(19) United States
(12) Patent Application Publication
(10) Pub. No.: US 2001/0002226 A1
(43) Pub. Date: May 31, 2001

(54) DRIVE MECHANISM USING SHAPE MEMORY ALLOY AND APPARATUS USING THE SAME

(76) Inventors: YOSHIHARU TANAKA, OSAKA (JP); SHOICHI MINATO, OSAKA (JP); AKIRA KOSAKA, OSAKA (JP); JUNICHI TANII, OSAKA (JP)

Correspondence Address: MCDERMOTT WILL & EMERY, 600 13TH STREET, N.W., WASHINGTON, DC, 20005-3096, US

(21) Appl. No.: 09/267,193

(22) Filed: Mar. 12, 1999

(30) Foreign Application Priority Data
Mar. 13, 1998 (JP) 10-080563
Feb. 2, 1999 (JP) 11-025282

(51) Int. Cl. G03B 17/00

(52) U.S. Cl. 396/440

(57) ABSTRACT

A drive mechanism using shape memory alloy which, even if used repeatedly, is free from the weakening or loss of the shape memorized by the driving member of the shape memory alloy and capable of driving driven members accurately for a long period of time, and an apparatus using this drive mechanism. The ambient temperature is measured by a temperature sensor and an electric current to be supplied to the driving member of the shape memory alloy is controlled according to the measured temperature. The driving member, when heated, is restored to its memorized shape, and moves the driven member to a determined position. When cooled, the driving member returns to its initial shape, and moves the driven member to its initial position.

This application is based on applications No. 10-80563 and No. 11-25282 filed in Japan, the contents of which are incorporated hereinto by reference.

### BACKGROUND OF THE INVENTION

1. Field of the Invention

The present invention relates to a drive mechanism using shape memory alloy and apparatus using such drive mechanism.

2. Prior Art

Drive mechanisms using shape memory alloy, because they involve a relatively small number of constituent parts and can be configured compactly in lighter weight, may replace conventional electromagnetic mechanisms, which will be elaborated upon below.

For instance, a camera based on the conventional silver salt film usually uses a roll film, each frame of which is fed to the exposure position to be exposed to the light reflected from the object and having passed the photographic lens. Since the frame of the film fed to the exposure position is slightly uneven, strained by the rolling or otherwise, a conventional camera has a constitution illustrated in FIGS. 32 and 33 to keep the film flat.

FIG. 32 shows a cross section including the optical axis of the camera and, FIG. 33 shows the relationship among parts of the film near the exposure position, the film aperture section and the pressing plate. A frame constituting a camera body 200 has a film aperture section AP in a position behind a photographic lens 201, and in the aperture section AP are formed film rails 202 to guide the film and pressing plate rails 203 with which a pressing plate 204, positioned behind the film, comes into contact.

The pressing plate 204 is fitted to the rear lid 210 of the camera body via springs 205. When the rear lid 201 is closed toward the camera body 200, the pressing plate 204 is pressed to the pressing plate rails 203 by the springs 205.

A step slightly greater than the thickness of the film is provided between each film rail 202 and each pressing plate rail 203, and the upper or lower end part of a film F is held in a gap formed by this step, and the rear face of the film F is pressed by the pressing plate 204, so that the flatness of the film F is somehow maintained.

However, since the film M is made of a pliable material and strained by the rolling, it is inevitable for the surface of the film F to come off the pressing plate 204 by Δt around the center of the film aperture section AP. However, no particular remedy has been taken against this problem, as Δt is usually regarded as being within the depth of focus of the photographic lens 201.

Exceptional cases include that of a special purpose camera, such as one used in the photomechanical process, where a fine image lens is required, the photographic conditions require a shallow depth of focus and the exposed area of the film is large, and a known arrangement to keep the film surface strictly flat uses a vacuum attraction device to attract the film to the pressing plate, inevitably resulting in a large size of hardware.

Even portable cameras for common use have come to require greater precision in the flatness of the film so as to enable high performance lenses now available to give full play to their enhanced capability. To meet this requirement, there is proposed a configuration in which a hermetic space is formed, enclosed by a diaphragm, behind the pressing plate, and the diaphragm is electromagnetically attracted to make the pressure in the hermetic space negative so that the film be attracted to the pressing plate (e.g. see U.S. Pat. No. 5,459,544).

However, regarding the aforementioned constitution to attract the film to the pressing plate, because it is an electromagnetical attracting mechanism, the disadvantage of tending to increase in size and weight, involving many constituent parts and increasing the manufacturing cost, has been pointed out.

If shape memory alloy is used here, as referred to above, the drive mechanism to keep the flatness of the film can conceivably be reduced in size and weight. However, the use of shape memory alloy in such a drive mechanism would require extra ingenuity in the control of heating of that shape memory alloy.

Thus, the aforementioned drive mechanism should be constant in operation, i.e. should function normally, even if the ambient temperature of its use varies. Especially a portable apparatus, such as a camera, which is used indoors and outdoors alike, may be employed in a very cold or very hot area, and accordingly has to be kept constant in performance in a wide range of temperature variation. This need is met by controlling the mechanism differently according to the environmental temperature. This technique is known as thermal feedback control, which enables the aforementioned drive mechanism to function normally irrespective of the environmental temperature.

However, even this thermal feedback control does not take account of the critical heating temperature, which is a characteristic of shape memory alloy. The critical heating temperature is the temperature beyond which the heated shape memory alloy would deteriorate in temperature variation characteristic and lose part of its shape memorized or durability. Therefore, even under thermal feedback control, overheating of shape memory alloy should be avoided.

### SUMMARY OF THE INVENTION

The principal object of the present invention is to provide a drive mechanism using a shape memory alloy which, even if used repeatedly, is free from the weakening or loss of the shape memorized in driving members of the shape memory alloy and capable of driving driven members accurately for a long period of time, and an apparatus using this drive mechanism.

Further object of the present invention is to realize a constitution which is enabled to operate normally and constantly irrespective of the environmental temperature and prevented from being deteriorated in temperature variation characteristic by the overheating of shape memory alloy.

Another object of the invention is to provide a drive mechanism using a shape memory alloy which prevents the shape memorized in driving members of the shape memory alloy from being weakened or lost by controlling the heating temperature of driving members of the shape memory alloy according to the environmental temperature, and driving driven members accurately for a long period of time, and an apparatus using this drive mechanism.

Still another object of the invention is to provide a drive mechanism using a shape memory alloy which is capable of controlling heating temperature according to the environmental temperature by regulating the current supplied to the members of the shape memory alloy, and driving driven members accurately for a long period of time, and an apparatus using this drive mechanism.

These objects are achieved in one aspect by controlling the current or voltage supplied to the shape memory alloy or the duty ratio thereof referring to the environment temperature so as not to exceed the critical heating temperature of the shape memory alloy.

Other features and objects of the present invention will become more apparent from the detailed description of the invention when taken in conjunction with the accompanying drawings.

### BRIEF DESCRIPTION OF THE DRAWINGS

FIG. 1 shows a cross section view of the configuration of a first embodiment of the invention in the initial state thereof;

FIG. 2 shows an elevation view of the configuration of FIG. 1 as viewed from the rear;

FIG. 3 shows a cross section view of the configuration of FIG. 1 in the state of attracting action;

FIG. 4 shows a cross section view of the configuration of a second embodiment of the invention in the initial state thereof;

FIG. 5 shows a cross section view of the configuration of FIG. 4 in the state of attracting action;

FIG. 6 shows a cross section view of the configuration of a third embodiment of the invention in the initial state thereof;

FIGS. 7(a) and 7(b) show cross section views of the configuration of a fourth embodiment of the invention in the initial state thereof;

FIGS. 8(a) and 8(b) show cross section views of the configuration of FIG. 7 in the state of attracting action;

FIG. 9 shows a cross section view of the configuration of a fifth embodiment of the invention in the initial state thereof;

FIG. 10 shows a cross section view of the configuration of FIG. 9 in the state of attracting action;

FIG. 11 shows a cross section view of the configuration of a sixth embodiment of the invention in the initial state thereof;

FIG. 12 shows an elevation view of the internal essential part of the configuration of FIG. 11 as viewed from the rear side;

FIGS. 13(a), 13(b) and 13(c) are diagrams showing how the temperature and displacement vary when a tensile load is applied to a wire made of shape memory alloy;

FIG. 14 is a diagram showing the electric current applied to shape memory alloy and the restored state of the memorized shape;

FIG. 15 is a diagram showing the voltage applied to shape memory alloy and the restored state of the memorized shape;

FIG. 16 is a diagram showing the film winding/rewinding mechanism of a camera;

FIG. 17 is a diagram showing the film feeding guide way of the film winding/rewinding mechanism of a camera;

FIG. 18 is a block diagram of a control circuit for a camera;

FIG. 19 is a flowchart for describing how control is accomplished in the first embodiment of the invention;

FIG. 20 is a flowchart for describing the processing to determine the amperage of the current to be applied to shape memory alloy;

FIG. 21 is a flowchart for describing how control is accomplished in the fourth embodiment of the invention;

FIG. 22 is a flowchart for describing another example of control accomplished in the fourth embodiment of the invention;

FIG. 23 shows a cross section view of the configuration of a seventh embodiment of the invention in the state of attracting action (the initial state);

FIG. 24 shows a cross section view of the configuration of FIG. 23 in the state of being relieved from attracting action;

FIGS. 25(a) and 25(b) show cross section views of the configuration of an eighth embodiment of the invention in the state of attracting action (the initial state);

FIGS. 26(a) and 26(b) show cross sections of the configuration of FIGS. 25(a) and 25(b) in the state of being relieved from attracting action;

FIG. 27 shows a cross section view of the configuration of a ninth embodiment of the invention in the state of attracting action (the initial state);

FIG. 28 shows an elevation view of the internal essential part of the configuration of FIG. 27 as viewed from the rear side;

FIG. 29 is a flowchart for describing how initial control is accomplished in the seventh embodiment of the invention;

FIG. 30 is a flowchart for describing the processing of film winding is accomplished in the seventh embodiment of the invention;

FIGS. 31(a) and 31(b) are flowcharts for describing how control is accomplished in the eighth embodiment of the invention;

FIG. 32 shows a cross section view including the optical axis of a conventional camera, and

FIG. 33 shows a cross section view of the configuration around the pressing plate of the conventional camera illustrated in FIG. 32.

### DETAILED DESCRIPTION OF THE PREFERRED EMBODIMENTS

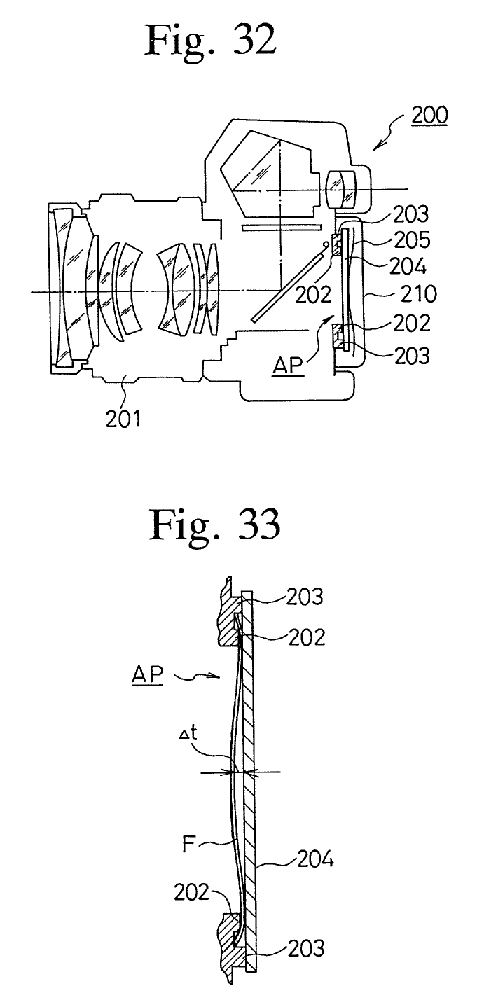

Preferred embodiments of the present invention will be described below in detail. In each of these embodiments, a drive mechanism using shape memory alloy is applied to the film flatness keeping device of a camera. The position of the aperture section where the film flatness keeping device is disposed is in the same part as the aperture section AP of the camera, which was cited in the foregoing description of the prior art with reference to FIGS. 32 and 33. In the following description, since the camera body is the same as that cited in the description of the prior art, the same description will be referred to, and only the film flatness keeping device of a camera provided with a drive mechanism using shape memory alloy will be described below.

[First Embodiment]

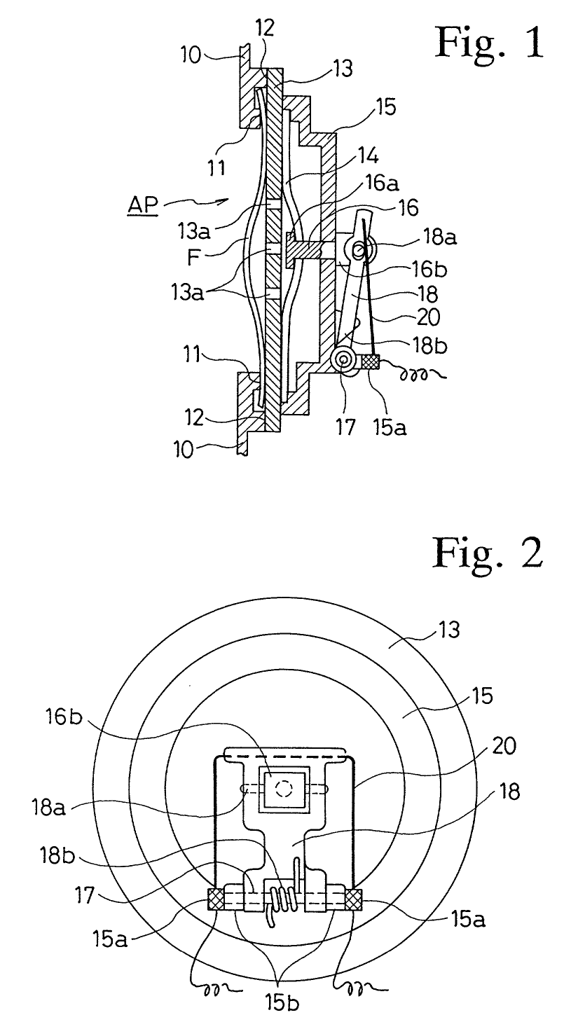

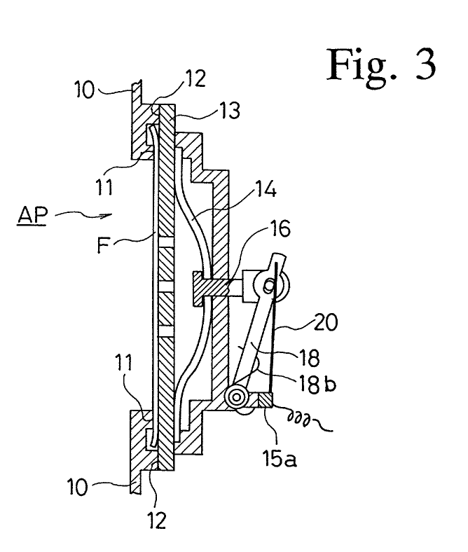

FIGS. 1 through 3 illustrate the configuration of a film flatness keeping device of the first embodiment of the invention. FIG. 1 shows a cross section view of the initial state thereof, i.e. a state in which a film is not attracted to a pressing plate, FIG. 2 shows an elevation view of the state shown in FIG. 1 as viewed from the rear side (the right side in FIG. 1) and FIG. 3 shows a cross section view in the operating state, i.e. a state in which the film is attracted to the pressing plate.

In FIGS. 1 through 3, reference numeral 10 denotes the frame part of the aperture section AP of the camera body. In the aperture section AP of the camera body are formed film rails 11 and pressing plate rails 12. Reference numeral 13 denotes a pressing plate disposed on the rear lid side of the camera (not shown), and the pressing plate 13 is provided with an orifice(s) 13a. The number of the orifice(s) 13a may be one or more. The reference numeral 15 denotes a supporting member fitted to the pressing plate 13. The pressing plate 13 and the supporting member 15 are so disposed that the pressing plate 13 be pressed against the pressing plate rails 12 by elastic members (not shown) such as springs when the rear lid of the camera is closed. Reference letter F denotes a film.

The supporting member 15 has a bearing 15b at its lower end, and a shaft 17 supported by the bearing 15b supports an attraction lever 18 swingably. An attraction shaft 16 penetrates the central part of the supporting member 15.

The end of the attraction shaft 16 on the pressing plate 13 side is formed into a disc-shaped end 16a, whose diameter is greater than the diameter of the shaft, and a block 16b, which is the other end of the attraction shaft 16, is provided with a pin 18a to be connected to near the upper end area of the attraction lever 18.

Reference numeral 14 denotes a diaphragm formed of rubber or any other suitable flexible material, and the parts around the diaphragm 14 are squeezed tightly by the pressing plate 13 and the supporting member 15 so that a hermetic space be formed between the pressing plate 13 and the diaphragm 14 except orifices 13a. The attraction shaft 16 penetrates the central part of the diaphragm 14, which is so disposed that, when the attraction shaft 16 shifts rightward in FIG. 1, the central part of the diaphragm 14 be pulled to expand the hermetic space between the pressing plate 13 and the diaphragm 14.

The attraction lever 18 is supported to be swingable around the shaft 17, and is subjected to the springing force of a spring 18b in the counter-clockwise direction in FIG. 1. A wire 20 formed of shape memory alloy is fixed to the upper end part of the attraction lever 18, and the lower end of the wire 20 is fixed to a terminal 15a provided on the supporting member 15 for supplying electric power feed. The wire 20 is fitted to the attraction lever 18, as is evident from FIG. 2, in such a manner that the wire 20 extends upward from one terminal 15a provided on the supporting member 15, then extends downward after penetrating the upper end of the attraction lever 18, and is fixed to the other terminal 15a provided on the supporting member 15.

To add, the wire 20 formed of shape memory alloy memorizes the shape in the contracting direction, and contracts into the memorized shape when it is heated.

Next will be described how this configuration operates. First, in a state where a film has been loaded in a camera and the frame to be exposed fed to the aperture section AP of the camera body, the attraction lever 18 is given a force in the counter-clockwise direction by the spring 18b, and the attraction shaft 16 is in the position illustrated in FIG. 1, where the film is not attracted to the pressing plate. Accordingly, there is a gap between the film F, which is slightly curved, and the pressing plate 13.

Then, when the wire 20 formed of shape memory alloy is electrified, the wire 20 is heated by its own resistance. As it is heated, the wire 20 contracts to the shape memorized in advance against the force of the spring 18b, and the upper end of the attraction lever 18 to which the wire is fixed turns in the clockwise direction in FIG. 1 to pull the attraction shaft 16 rightward in FIG. 1. As this action also pulls the central part of the diaphragm 14 rightward, the hermetic space between the pressing plate 13 and the diaphragm 14 is expanded to generate a negative pressure, which causes the film F before the pressing plate 13 to be attracted to the pressing plate 13 and the part of the film F in the aperture section AP to be kept flat. FIG. 3 shows a cross section in an operating state in which the wire 20 is heated.

When the film F is kept flat, pictures are taken, and upon completion of photographing, heating of the wire 20 formed of shape memory alloy is stopped. As the wire 20 has been cooled by the ambient air, it returns to its initial shape and the attraction lever 18 is restored by the spring 18b to its position in the initial state shown in FIG. 1. The attraction shaft 16 and the diaphragm 14 also return to their respective positions in the initial state, so that the film F is relieved from attraction to the pressing plate 13 to be enabled to be wound forward.

[Second Embodiment]

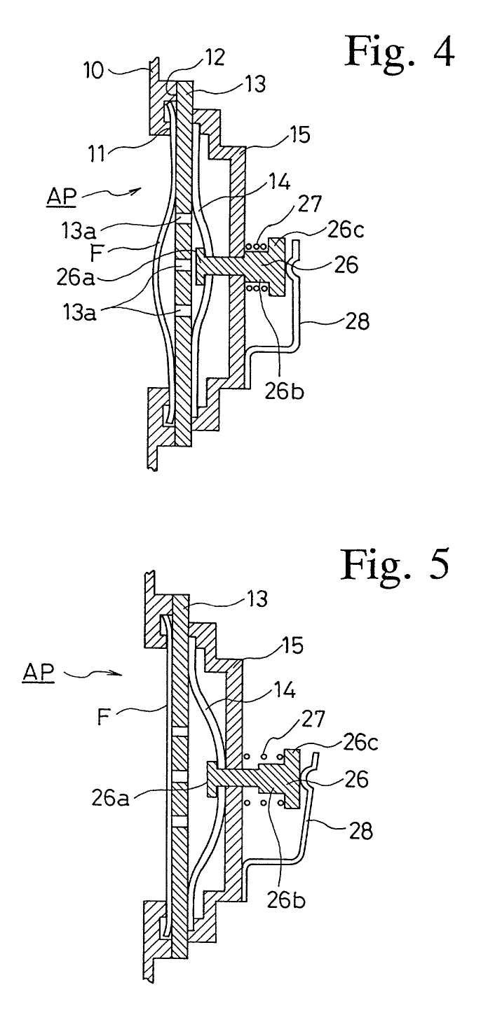

FIGS. 4 and 5 illustrate the configuration of a film flatness keeping device of the second embodiment of the invention. FIG. 4 shows a cross section view of the initial state thereof, and FIG. 5, across section view in the operating state.

The same members as in the first embodiment described with reference to FIGS. 1 through 3 are assigned respectively the same reference signs, and their detailed description is dispensed with, but only the differences will be described.

Referring to FIGS. 4 and 5, the film rails 11 and the pressing plate rails 12 are formed in the aperture section AP of the camera body 10. The pressing plate 13 disposed on the rear lid side of the camera is provided with the orifice(s) 13a. The supporting member 15 fitted to the pressing plate 13 is so disposed that the pressing plate 13 be pressed against the pressing plate rails 12 by elastic members (not shown) such as springs when the rear lid of the camera is closed. Reference letter F denotes a film.

An attraction shaft 26 penetrates the central part of the supporting member 15, and the end of the attraction shaft 26 on the pressing plate 13 side is formed into a disc-shaped end 26a, whose diameter is greater than the diameter of the shaft, while the other end of the attraction shaft 26 is formed into a large diameter section 26b, whose diameter is greater than the diameter of the shaft, and an end part of section 26c.

Around the large diameter part 26b of the attraction shaft 26 is fitted a coil spring 27 formed of shape memory alloy, the outside end face of the part 26b of the attraction shaft 26 is arranged to contact a tip of a leaf spring 28 to press the attraction shaft 26 toward the pressing plate 13. The other tip of the leaf spring 28 is fixed to the supporting member 15.

The coil spring 27 formed of shape memory alloy, whose length is contracted at normal temperature, is extended by heating because it is memorized a lengthened shape (see the shape of the coil spring 27 shown in FIG. 5).

Next will be described how this configuration operates. First, in a state where a film has been loaded in a camera and the frame to be exposed fed to the aperture section AP of the camera body, the attraction shaft 26 is in the position illustrated in FIG. 1, where the film is not attracted to the pressing plate 13 because the attraction shaft 26 is pressed toward the pressing plate 13 by the leaf spring 28. Accordingly, there is a gap between the film F, which is slightly curved, and the pressing plate 13.

When the coil spring 27 formed of shape memory alloy is electrified, the coil spring 27 is heated by its own resistance. As it is heated, the coil spring 27 extends into the shape memorized in advance against the force of the leaf spring 28 to pull the attraction shaft 26 rightward in FIG. 4. As this action also pulls the central part of the diaphragm 14 rightward, the hermetic space between the pressing plate 13 and the diaphragm 14 is expanded to generate a negative pressure, which causes the film F before the pressing plate 13 to be attracted to the pressing plate 13 and the part of the film F in the aperture section AP to be kept flat. FIG. 5 shows a cross section in an operating state in which the coil spring 27 is heated.

When the film F is kept flat, pictures are taken, and upon completion of photographing, heating of the coil spring 27 formed of shape memory alloy is stopped by discontinuing the feeding of electricity. As the coil spring 27 has been cooled and returns to its initial shape, the attraction shaft 26 is restored by the leaf spring 28 to its position in the initial state shown in FIG. 4, and the film F is relieved from attraction to the pressing plate 13 and enabled to be wound forward.

[Third Embodiment]

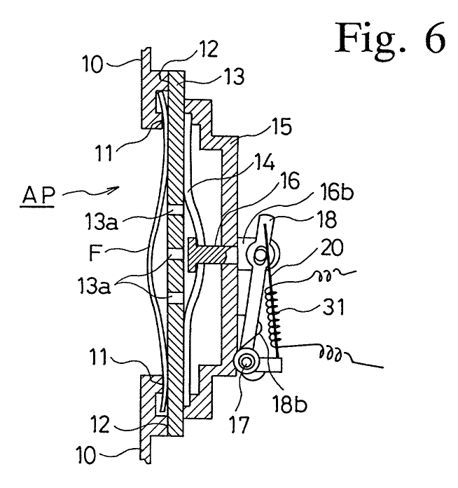

FIG. 6 illustrates the configuration of a film flatness keeping device of the third embodiment of the invention. FIG. 6 shows a cross section view of the initial state thereof.

Since this is a configuration resembling that of the first embodiment described with reference to FIGS. 1 through 3, the same members are assigned respectively the same reference signs, and their detailed description is dispensed with, but only the differences will be described.

The configuration illustrated in FIG. 1, in which the wire 20 formed of shape memory alloy is fixed to near the upper end area of the attraction lever 18 for pulling the attraction shaft 16, is such that direct supply of electricity of the wire 20 formed of shape memory alloy causes the wire 20 to be heated by its own resistance and to be deformed by contraction.

As opposed to that, the third embodiment is so configured that the wire 20 formed of shape memory alloy and is not directly electrified, but a heating element 31, consisting of a nickel-chrome wire or the like, is disposed outside the wire 20, and electrification of this heating element 31 causes the wire 20 to be heated and deformed by contraction.

Description of the configuration and operation of other parts is dispensed with, because they are the same as those of the first embodiment.

[Fourth Embodiment]

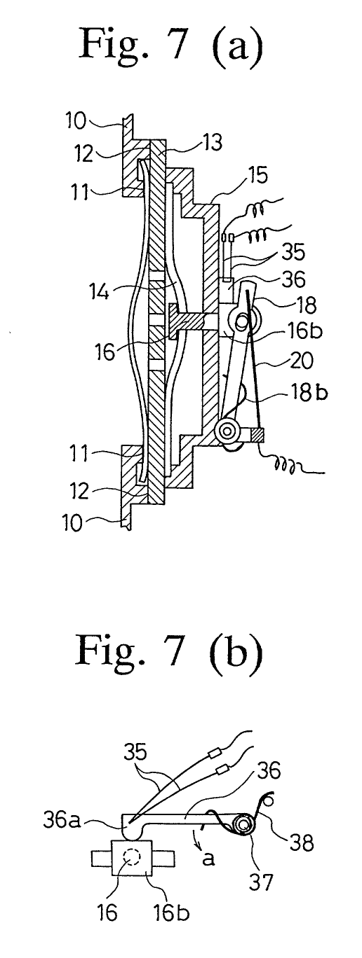

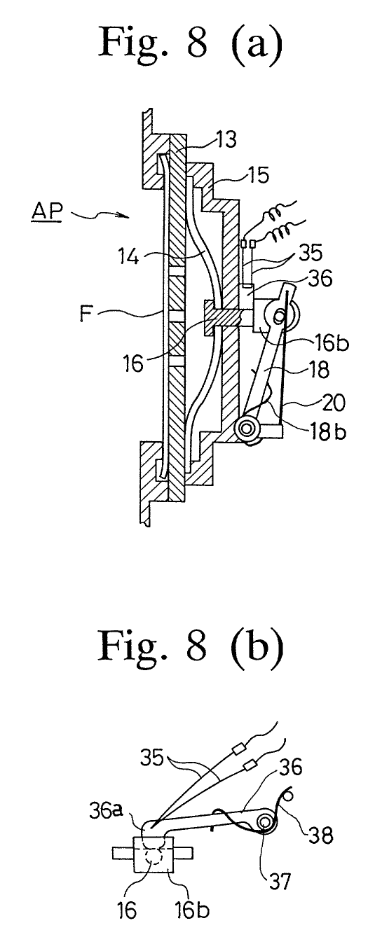

FIGS. 7(a) to 8(b) illustrate the configuration of a film flatness keeping device of the fourth embodiment of the invention. FIG. 7(a) shows a cross section view of the initial state thereof and FIG. 7(b) is a diagram illustrating the configuration and operation of the engaging part in the initial state. FIG. 8(a) shows a cross section view of the operating state thereof and FIG. 8(b) is a diagram illustrating the configuration and operation of the engaging part in the operating state.

The fourth embodiment differs from the first embodiment in that, after the wire 20 formed of shape memory alloy is electrified and the attraction shaft 16 is pulled by the attraction lever 18, the pulled state of the attraction shaft 16 is maintained even when the power feed to the wire 20 is interrupted. This disposition makes it possible, for instance, when shutter is kept open and exposure is continued for a long period, to interrupt the power feed to the wire 20 once the film is attracted to the pressing plate, and thereby to save power consumption.

Since the configuration of the fourth embodiment resembles that of the first embodiment described with reference to FIGS. 1 through 3, the same members are assigned respectively the same reference signs, and their detailed description is dispensed with, but only the differences will be described.

As illustrated in FIG. 7(a), the attraction shaft 16 penetrates the supporting member 15, and a restraining lever 36 is arranged above that penetrating attraction shaft 16.

One end of the restraining lever 36, as shown in FIG. 7(b), is supported by a shaft 37, and given a force in the direction of arrow a by a spring 38. Near the tip 36a of the restraining lever 36 is fixed a wire 35. The wire 35 is formed of shape memory alloy and is memorized a shape in the contracting direction. The tip 36a of the restraining lever 36 is formed in dimensions matching a gap which is formed between the supporting member 15 and the block 16b of the attraction shaft 16 when the attraction shaft 16 moves rightward in FIG. 7(a), so that the tip 36a is caused by the force of the spring 38 to drop into this gap when the attraction shaft 16 moves rightward in FIG. 7(a).

Next will be described how this configuration operates. First, in a state where a film has been loaded in a camera and the frame to be exposed fed to the aperture section AP of the camera body, the attraction shaft 16 is in the position illustrated in FIG. 7(a), where the film is not attracted to the pressing plate 13 because the wire 20 formed of shape memory alloy is not electrified and the attraction shaft 16 is not pulled by the attraction lever 18. Accordingly, there is a gap between the film F, which is slightly curved, and the pressing plate 13. The tip 36a of the restraining lever 36, as illustrated in FIGS. 7(a) and 7(b), is riding on the block 16b of the attraction shaft 16.

When the wire 20 formed of shape memory alloy is electrified and thereby heated, the attraction shaft 16 is pulled by the contracting displacement of the wire 20, the state of the device changed as illustrated in FIG. 8(a) and, since the central part of the diaphragm 14 is also pulled rightward, the hermetic space between the pressing plate 13 and the diaphragm 14 is expanded to generate a negative pressure, which causes the film F before the pressing plate 13 to be attracted to the pressing plate 13 and the part of the film F in the aperture section AP to be kept flat.

As, at this time, the tip 36a of the restraining lever 36 is caused by the force of the spring 38 to drop into the gap formed between the supporting member 15 and the block 16b of the attraction shaft 16, resulting in the state illustrated in FIGS. 8(a) and 8(b), the attraction shaft 16 does not return to its initial position even when the power feed to the wire 20 is interrupted.

The restraining lever 36 can be lifted from the gap between the supporting member 15 and the block 16b of the attraction shaft 16, and restored to its initial position shown in FIG. 7(b), by electrifying and heating the wire 35 formed of shape memory alloy which is fixed near the tip 36a of the restraining lever 36 and thereby generating a contracting displacement in the wire 35 against the force provided by the spring 38. After the restraining lever 36 has returned to its initial position, the power feed to the wire 35 can be interrupted.

In the above-described configuration, the restraining lever 36 can be restored to its initial position more easily by electrifying and heating the wire 20 to pull again the attraction shaft 16 before electrifying and heating the wire 35 because the prior heating of the wire 20 results in slight expansion of the gap between the supporting member 15 and the block 16b of the attraction shaft 16.

[Fifth Embodiment]

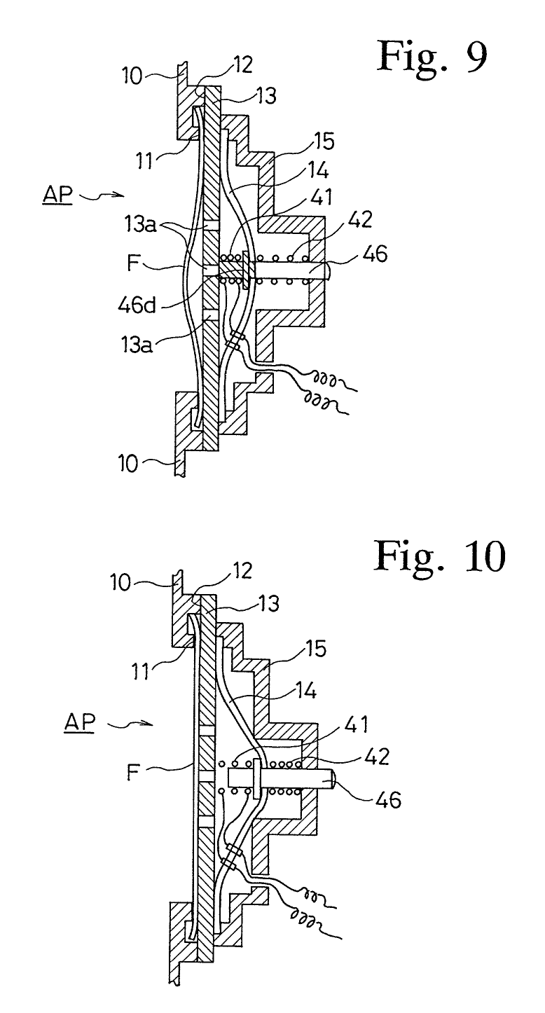

The fifth embodiment of the invention is a film flatness keeping device in which the diaphragm and a drive power source for shifting the diaphragm are disposed within a hermetic chamber. FIG. 9 shows a cross section view of the initial state of the film flatness keeping device, and FIG. 10 is a cross section view of the operating state.

The same members as in the first embodiment described with reference to FIGS. 1 through 3 are assigned respectively the same reference signs, and their detailed description is dispensed with, but only the differences will be described.

Referring to FIGS. 9 and 10, a hermetic chamber is constituted with the pressing plate 13 disposed on the rear lid side of the camera (not shown) and the supporting member 15 fitted to the pressing plate 13 except orifices 13a.

An attraction shaft 46 penetrates the central part of the supporting member 15, and around a middle part of the attraction shaft 46 is formed a disc-shaped member 46d, whose diameter is greater than that of the shaft. A coil spring 41 is fitted around a part of the attraction shaft 46 closer to the pressing plate 13 than the disc-shaped member 46d, and the diaphragm 14 and a coil spring 42 is fitted around a part of the attraction shaft 46 closer to the supporting member 15 than the disc-shaped member 46d. The coil spring 42 is an ordinary coil spring made of steel or some other elastic material.

The coil spring 41 formed of shape memory alloy, whose length is contracted at normal temperature, is extended by heating because it is memorized a lengthened shape (see the shape of the coil spring 41 shown in FIG. 10).

Next will be described how this configuration operates. First, in a state where a film has been loaded in a camera and the frame to be exposed fed to the aperture section AP of the camera body, the attraction shaft 46 is in the position illustrated in FIG. 9, where the film is not attracted to the pressing plate 13 because the disc-shaped member 46d of the attraction shaft 46 is pressed toward the pressing plate 13 by the leaf spring 42, and accordingly, there is a gap between the film F, which is slightly curved, and the pressing plate 13.

Then, when the coil spring 41 formed of shape memory alloy is electrified, the coil spring 41 is heated by its own resistance. As it is heated, the coil spring 41 extends into the shape memorized in advance against the force of the coil spring 42 to push the disc-shaped member 46d of the attraction shaft 46 rightward in FIG. 9 into the state shown in FIG. 10. As this action also pulls the central part of the diaphragm 14 rightward, the hermetic space between the pressing plate 13 and the diaphragm 14 is expanded to generate a negative pressure, which causes the film F before the pressing plate 13 to be attracted to the pressing plate 13 and the part of the film F in the aperture section AP to be kept flat.

When the film F is kept flat, pictures are taken, and upon completion of photographing, heating of the coil spring 41 formed of shape memory alloy is stopped. As the coil spring 41 has been cooled and returns to its initial shape, the attraction shaft 46 is restored by the coil spring 41 to its position in the initial state shown in FIG. 9, and the film F is relieved from attraction to the pressing plate 13 and enabled to be wound forward.

The above-described configuration allows the hardware to be reduced in size because the diaphragm 14, the attraction shaft 46 for shifting the diaphragm 14, and the drive power source for shifting the diaphragm 14 including the coil spring 41 formed of shape memory alloy and the coil spring 42 formed of an ordinary elastic material can be arranged within a hermetic chamber formed by the pressing plate 13 and the supporting member 15.

[Sixth Embodiment]

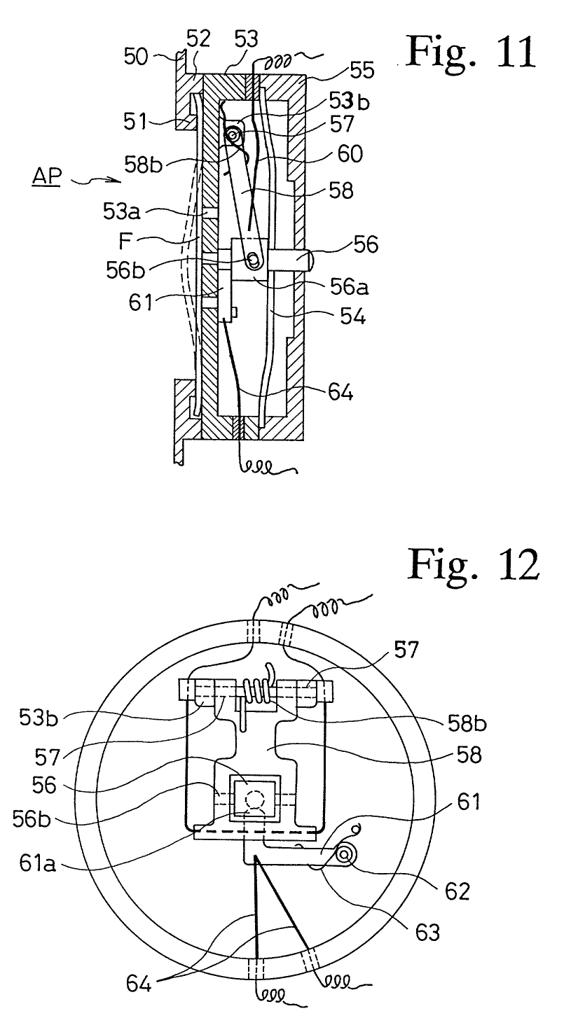

The sixth embodiment of the invention is another film flatness keeping device in which the diaphragm and a drive power source for shifting the diaphragm is disposed within a hermetic chamber. FIGS. 11 and 12 illustrate the film aperture section AP of the camera. FIG. 11 is a cross section view of the initial state thereof, and FIG. 12 is an elevation view of the essential parts thereof as viewed from the rear side (the right side in FIG. 11).

Referring to FIGS. 11 and 12, a hermetic chamber is constituted with the pressing plate 53 disposed on the rear lid side of a camera (not shown) and a supporting member 55 fitted to the pressing plate 55 except orifices 53a.

In FIGS. 11 and 12, reference numeral 50 denotes a camera body, in whose aperture section AP are formed film rails 51 and pressing plate rails 52. A pressing plate 53 disposed on the rear lid side of the camera (not shown) is provided with orifices 53a for attracting the film F to the pressing plate 53.

On the rear side (the side not facing the film F) of the pressing plate 53, a bearing 53b is provided at the top, and a shaft 57 supported by the bearing 53b swingably supports the upper end of an attraction lever 58.

An attraction shaft 56 penetrates the central part of the supporting member 55, and around the central part of the attraction shaft 56 is formed a block 56a, and the lower end of an attraction lever 58 is connected to the block 56a with a pin 56b.

Reference numeral 54 denotes a diaphragm formed of rubber or any other suitable flexible material, and the parts around the diaphragm 54 are squeezed tightly against each other by the pressing plate 53 and the supporting member 55 so that a hermetic space be formed between the pressing plate 53 and the diaphragm 54 except orifices 53a. The attraction shaft 56 penetrates the central part of the diaphragm 54. When the attraction shaft 56 shifts rightward in FIG. 11, the central part of the diaphragm 54 be pulled to expand the hermetic space between the pressing plate 53 and the diaphragm 54.

The attraction lever 58 is supported to be swingable around the shaft 57, and is subjected to the springing force of a spring 58b in the clockwise direction in FIG. 11. A wire 60 formed of shape memory alloy is fixed to the lower end part of the attraction lever 58, and the upper end of the wire 60 is fixed to an electric power terminal 55a provided on the supporting member 55. The wire 60 formed of shape memory alloy memorizes a shape in the contracting direction, and contracts to the memorized shape when heated.

On the rear side (the side not facing the film F) of the pressing plate 53, as illustrated in FIG. 11, a restraining lever 61 is provided underneath the attraction shaft 56. One end of the restraining lever 61, as illustrated in FIG. 12, is swingably supported by a shaft 62 fitted onto the pressing plate 53, and given a force in the clockwise direction by a spring 63. Near a tip 61a of the restraining lever 61 is fitted a wire 64 formed of shape memory alloy, which memorizes a shape in the contracting direction.

The tip 61a of the restraining lever 61 is formed in suitable dimensions matching a gap formed between pressing plate 53 and block 56a. When the attraction shaft 56 shifts rightward as shown in FIG. 11, the tip 61a of the restraining lever 61 is pinched in a gap between the pressing plate 53 and the block 56a of the attraction shaft 56.

Next will be described the operation of this configuration. In the initial state, no electric power is fed to either the wire 60 formed of shape memory alloy or the wire 64 also formed of shape memory alloy. Since the attraction lever 58 is given a force in the clockwise direction by the spring 58b, and the tip 61a of the restraining lever 61 is off the gap between the supporting member 55 and the block 56a of the attraction block 56, the block 56a is in contact with the rear side (the side not facing the film F) of the pressing plate 53 and, being in the position illustrated in FIG. 11, in a state of not attracting the film to the pressing plate. At this time, the central part of the film F, as indicated by dotted lines in FIG. 11, is off the surface of the pressing plate 53.

Then, when the wire 60 formed of shape memory alloy is electrified and heated, the attraction lever 58 turns in the counter-clockwise direction around the shaft 57 against the force of the spring 58b to shift the attraction shaft 56 connected to the attraction lever 58 rightward in FIG. 11. As this action also shifts rightward the central part of the diaphragm 54 engaged with the block 56a of the attraction shaft 56, the hermetic space between the pressing plate 53 and the diaphragm 54 is expanded to generate a negative pressure, which causes the film F to be attracted to the pressing plate 53 and thereby kept flat.

As the attraction shaft 56 connected to the attraction lever 58 shifts rightward in FIG. 11, the tip 61a of the restraining lever 61, positioned underneath the attraction shaft 56, is caused by the force of the spring 63 in the clockwise direction to be thrust upward into and is pinched in the gap between the pressing plate 53 and the block 56a of the attraction shaft 56. Then, if the power supply to the wire 60 formed of shape memory alloy is interrupted and the wire 60 is returned to initial shape by cooling, the attraction shaft 56 does not return to its initial position.

The restraining lever 61 can be caused to come out of the gap between the pressing plate 53 and the block 56a of the attraction shaft 56 and restored to its initial state by electrifying and heating the wire 64 formed of shape memory alloy fixed to the restraining lever 61. By heating the wire 64, memorized shape of the wire 64 is restored, and pulls the restraining lever 61 downward in FIG. 12 against the force in the clockwise direction provided by the spring 63.

This causes the restraining lever 61 to come out of the gap between the pressing plate 53 and the block 56a and return to its initial position. In this process, the restraining lever 61 can be restored to its initial position more easily by electrifying and heating the wire 60 to shift the attraction shaft 16 rightward again before electrifying and heating the wire 64 because the prior heating of the wire 60 results in slight expansion of the gap between the pressing plate 53 and the block 56a.

[Heating of Members Formed of Shape Memory Alloy]

Next will be described how wires and coil springs (hereinafter referred to as wires) formed of shape memory alloy are heated. In the above-described embodiments, the Joule heat generated by either feeding an electric current directly to a wire formed of shape memory alloy or to a heating element disposed around a wire formed of shape memory alloy and its equilibrium with the ambient temperature determine the temperature of the a wire formed of shape memory alloy. Therefore the amperage of the current to be applied has to be adjusted according to the ambient temperature, and it is undesirable to heat the shape memory alloy far beyond its transformation temperature (usually 60° C. or more) because it would obscure the memorized shape or deteriorate durability.

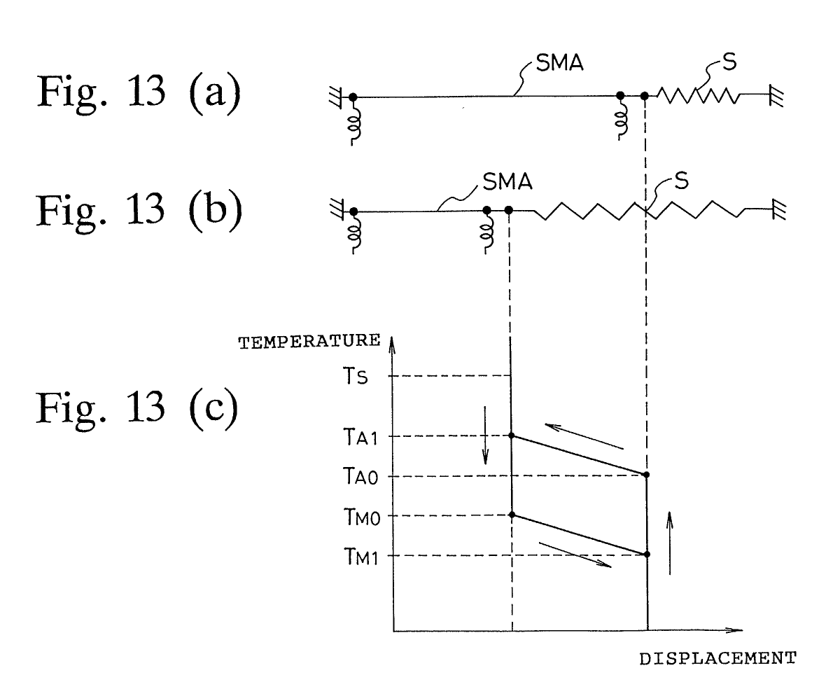

FIGS. 13(a) to 13(c) illustrates the relationship between the temperature of a shape memory alloy wire SMA memorizing a predetermined shrunken shape and the quantity of its displacement. The shape memory alloy wire SMA is supposed to be subjected to a certain tensile load by a spring S. In its unheated state (at a temperature of less than TM1), the wire SMA, extended by the spring S, is in the state illustrated in FIG. 13(a). When it is heated, the wire SMA is contracted to its memorized shape and the spring S is extended, resulting in the state shown in FIG. 13(b).

The relationship between the temperature of the shape memory alloy wire SMA and the quantity of its displacement will be explained below with reference to FIG. 13(c). When the temperature of the wire SMA is less than Martensite finish temperature TM1, which is the phase transformation finish temperature upon cooling, the wire SMA is in an extended state. As electric power feed to the wire SMA is started to heat it and the temperature of the wire SMA rises beyond Austenite start temperature TA0, which is the phase transformation start temperature upon heating, transformation to the high temperature form starts, and the wire SMA begins to contract against the tension of the spring S. As the temperature of the wire SMA further rises and reaches Austenite finish temperature TA1, the phase transformation finish temperature upon heating, the transformation to the high temperature form is finished and the deformation of wire SMA is completed.

Then, when the power feed to the wire SMA is interrupted and its temperature drops less than Martensite start temperature TM0, the phase transformation start temperature upon cooling, the wire SMA starts transformation to the low temperature form, and begins to be extended by the tension of the spring S. As the temperature of the wire SMA further drops and reaches Martensite finish temperature TM1, the transformation to the low temperature form is finished and deformation of wire SMA to the initial state is completed.

The temperature dependence of the displacement or deformation of a driving member, such as the wire SMA consisting of shape memory alloy, has a hysteretic characteristic as shown in FIG. 13(c). Therefore, a sufficient quantity of displacement or deformation for the wire SMA consisting of shape memory alloy can be achieved by heating of the wire SMA at a temperature less than TM1, Martensite finish temperature, and continuing to heat it over TA1, Austenite temperature. However, heating over the critical heating temperature TS (usually TS=TA1+60° C.) is undesirable because it would obscure the memorized shape or deteriorate durability.

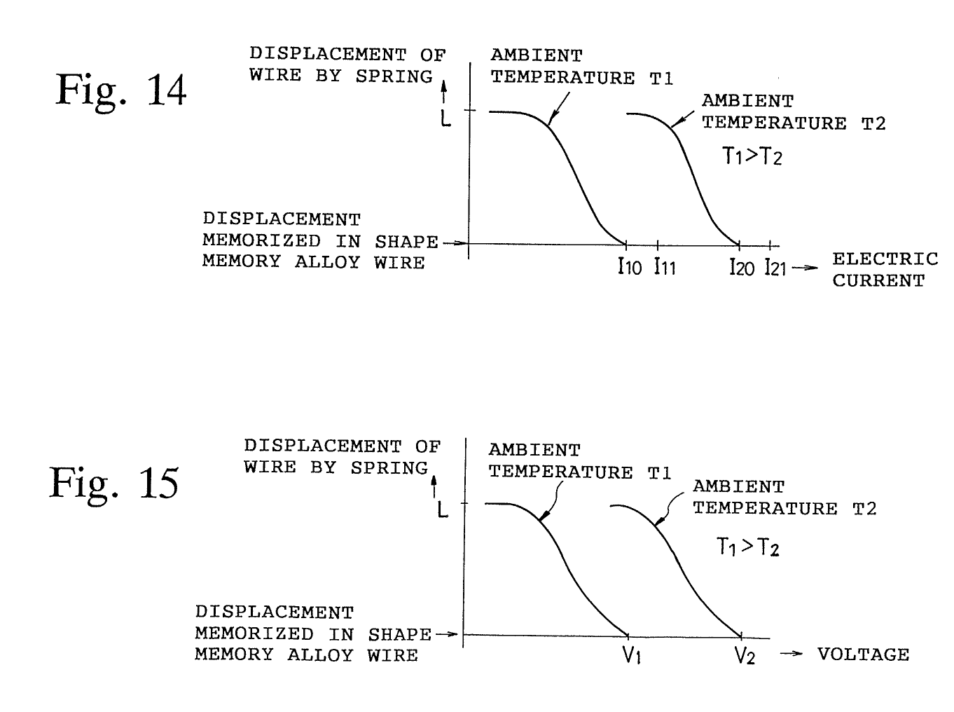

FIG. 14 illustrates, with respect to the shape memory alloy wire memorizing a predetermined shrunken shape, the relationship between the amperage of the current heating the wire SMA and the restored displacement memorized in the shape memory alloy under the ambient temperatures T1 and T2.

Thus it is shown that, in an environment of ambient temperature T1, while the wire SMA is extended length L by the tension of the spring in an unheated state where no current is flowed, the wire SMA contracts against the tension of the spring as the current is increased, and the temperature of the wire SMA reaches TA1, Austenite finish temperature, at an amperage of I10 to restore the wire SMA to its memorized shape.

It is further shown that, in an environment of ambient temperature T2 as well, while the wire SMA is extended length L by the tension of the spring in an unheated state where no current is flowed, the wire SMA contracts against the tension of the spring as the current is increased, and the temperature of the wire SMA reaches TA1, Austenite finish temperature, at an amperage of I20 to restore the wire SMA to its memorized shape.

As explained earlier with reference to FIG. 13, since the temperature of the wire SMA is acceptable if it is less than the critical heating temperature TS (usually TS=TA1+ 60° C.) and more than the Austenite finish temperature is more than TA1, the amperage of the current for heating can be set to a relatively high level of I11 or I21 within the range of not surpassing the critical heating temperature TS.

Thus, in order to restore the shape memory alloy wire to its memorized shape without fail and thereby to achieve the required quantity of displacement, the amperage can be set within the range of I10 to I11 in an environment of ambient temperature T1 or in the range of I20 to I21 in an environment of ambient temperature T2.

Where the ambient temperature range of shape memory alloy widely varies with the environment of use, two or more ambient temperatures Tn can be set in advance according to the environment of use, an amperage In for heating to each ambient temperature Tn determined, and the amperage In for heating in each particular case selectively determined according to the detected ambient temperature Tn. Or else, for instance, a linear function formula of the amperage In for heating corresponding to each ambient temperature Tn can be determined in advance, and the amperage In can be obtained for a given case by calculation from the detected ambient temperature Tn.

Although the foregoing description referred to adjustment of the amperage of the current to be applied in controlling the heating of the shape memory alloy wire, exactly the same heating control effect can be achieved by adjusting the voltage to be applied as in the case of controlling the amperage.

FIG. 15 illustrates relationship between the voltage and the restored displacement memorized in the shape memory alloy under the ambient temperatures T1 and T2. It shows that the memorized shape is restored at an applied voltage of V1 where the ambient temperature is T1, and that it is restored at an applied voltage of V2 where the ambient temperature is T2.

The foregoing description referred to a case in which the amperage or the voltage applied is adjusted in controlling the heating of the shape memory alloy wire. It is also possible to apply instead a pulse of a constant amperage or voltage and control the pulse width, i.e. the duty ratio. A duty ratio Dn for a shorter power feed time can be selected when the ambient temperature Tn is high, and a duty ratio Dn for a longer power feed time can be selected when the ambient temperature Tn is low. In this case, the dependence of the duty ratio on the ambient temperature Tn can be determined in advance by, for instance, a linear functional formula, and the duty ratio Dn can be obtained for a given case by calculation from the detected ambient temperature Tn.

In this case as well, as explained earlier with reference to FIG. 13, since the temperature of the wire SMA is acceptable if it is more than Austenite finish temperature TA1 and less than the predetermined critical heating temperature TS (usually TS=TA1+60° C.), the voltage to be applied for heating, or the duty ratio, can be set to a relatively high voltage, or a duty ratio for a relatively long power feed time, within the range of not surpassing the critical heating temperature TS.

[Film Winding/Rewinding Mechanism of the Camera and the Camera Control Circuit]

As any film flatness keeping devices explained in the embodiments are related to the film winding/rewinding mechanism of the camera and camera control operation, the film winding/rewinding mechanism and the camera control circuit will be described below.

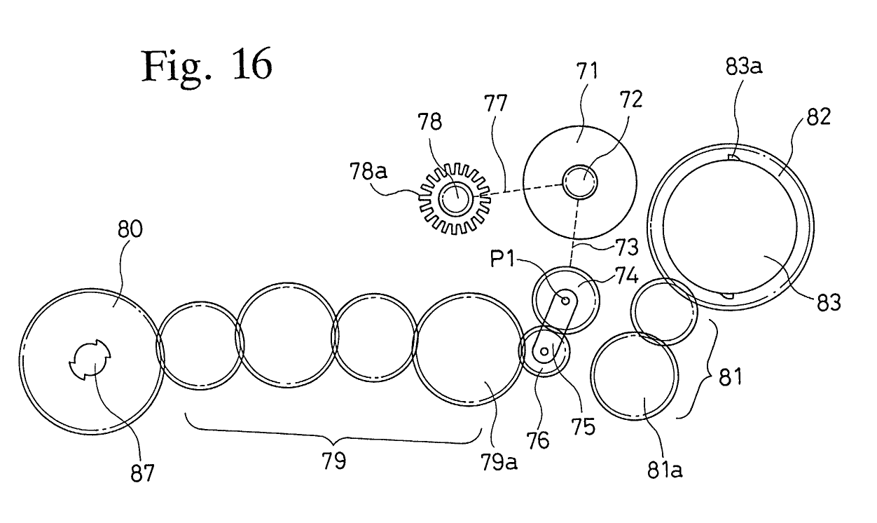

FIG. 16 illustrates the film winding/rewinding mechanism of a camera, wherein reference numeral 71 denotes a motor, to whose rotor shaft is fixed a gear 72. The rotation of the motor 71 is transmitted via a gear train 73 to the sun gear 74 of a planetary gear mechanism.

At the tip of a lever 75 rotatably fitted to the shaft P1 of the sun gear 74 of the planetary gear mechanism consisting of gears 74 and 76 is mounted the planet gear 76, which engages with the sun gear 74. Between the sun gear 74 and the lever 75 is provided a friction mechanism. Depending on the rotating direction of the sun gear 74, the lever 75 turns around the shaft P1 clockwise or counter-clockwise, and the planet gear 76 engages with a gear 79a of a rewinding gear train 79, or with a gear 81a of a winding gear train 81.

A gear 78 is connected to the gear 72 via an accelerating gear train 77, and the rotation of the motor 71 are accelerated and transmitted to gear 78, to which a disk 78a of an encoder is fixed. Rotation of the disk 78a between photocouplers (not shown) causes pulse signals to be supplied.

When the motor 71 rotates in a first predetermined direction and the sun gear 74 turns in the clockwise direction in FIG. 16, the lever 75 turns in the clockwise direction around the shaft P1, and the planet gear 76 engages with the gear 79a of the rewinding gear train 79, resulting in the state shown in FIG. 16. In this state, as the rotation of the motor 71 in the first direction is transmitted via the rewinding gear train 79 to a gear 80 provided with a fork integrated with it, the folk can turn the spool shaft of a film cartridge to rewind the film.

When the motor 71 rotates in a second direction, reverse to the first, and the sun gear 74 turns in the counter-clockwise direction in FIG. 16, the lever 75 turns in the counter-clockwise direction around the shaft P1, and the planet gear 76 engages with the gear 81a of the winding gear train 81. In this state, the rotation of the motor 71 in the second direction are transmitted via the winding gear train 81 to a gear 82 provided with a spool 83 integrated with it. As the spool 83 is provided with pawls 83a to engage with perforations of the film, the rotation of the gear 82 can turn the spool 83 to wind the film.

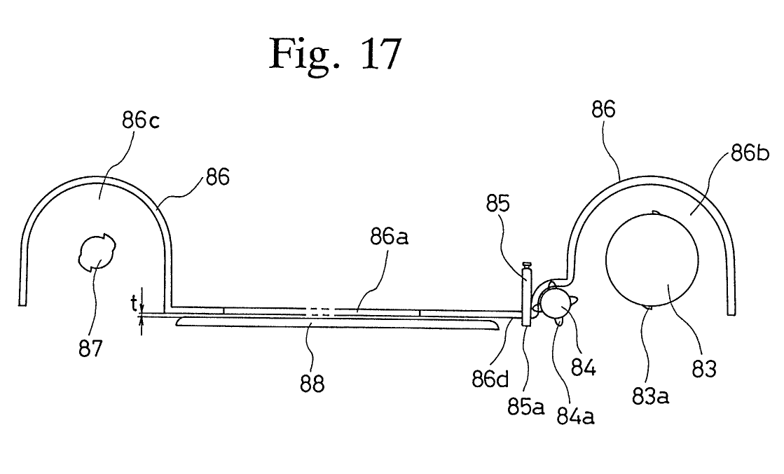

FIG. 17 illustrates the film feeding guide way of the film winding/rewinding mechanism. Reference numeral 86 denotes a camera body, in which a picture frame 86a, a spool chamber 86b and a cartridge chamber 86c are formed. The spool chamber 86b houses the spool 83, and a film wound on the spool 83 is housed into the spool chamber 86b.

In the cartridge chamber 86c is provided a fork 87, with which the spool shaft of a film cartridge engages when the cartridge is loaded into the cartridge chamber 86c, and the rotation of the fork 87 causes the spool shaft to turn.

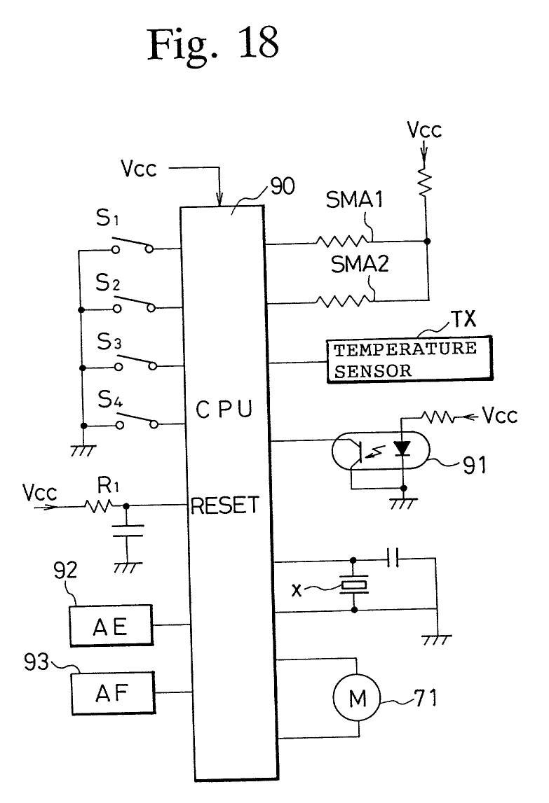

Reference numeral 84 denotes a follower sprocket, which is provided with pawls 84a engaging with the perforations of the film, and the follower sprocket 84 turns interlocked with the winding/rewinding of the film. The rotation of the follower sprocket 84 serves to turn a switch S1 (see FIG. 18) on or off, and the state of film feeding, such as the feeding of one frame of film or the number of frames photographed, is detected by the pulse signal outputted from switch S1.

Reference numeral 85 denotes a film detecting pin, which is given a force in the downward direction in FIG. 17 by a spring (not shown). When a film is loaded and comes to a point underneath the film detecting pin 85, the pin 85 is thrust upwardly and turned on a switch S2 (see FIG. 18) to output a film detection signal. Reference numeral 88 denotes a pressing plate. This pressing plate section has the configuration earlier described with reference to FIGS. 1 through 12.

FIG. 18 is a block diagram of a camera control circuit. Constant voltage Vcc regulated by a constant voltage circuit (not shown) is supplied to the CPU 90. To the reset terminal of the CPU 90 is connected to a resistor R1, and is supplied the constant voltage Vcc, and the CPU 90 is reset when the power level changes from L to H, such as when the battery is replaced. To the CPU 90 is also connected a quartz oscillator X to supply clock signals.

To the input/output (I/O) port of the CPU 90 are connected the switch S1 for detecting the state of film feeding, the switch S2 for supplying a film detection signal, a release switch S3, a switch S4 for instructing film rewinding prior to the exposure of the laser frame, a photocoupler 91 for detecting the rotation of disk 78a of the encoder driven by the motor 71 and outputting a pulse signal, and heaters SMA1 and SMA2 for heating wires and other members consisting of shape memory alloy.

Regarding the heaters SMA1 and SMA2 here, as explained earlier, wires or driving member made of shape memory alloy themselves are referred to as heaters SMA1 and SMA2 where electric currents are flowed directly to wires or any other members consisting of shape memory alloy, but where separate heaters are used, they are referred to as SMA1 and SMA2.

Besides these elements, a temperature sensor TX for detecting the ambient temperature of wires or other members consisting of shape memory alloy, an AE circuit 92 for controlling exposure, an AF circuit 93 for detecting the focus, and focus control, and the motor 71 for feeding the film are connected to the I/O output of the CPU 90.

[Control of the Attraction of the Film to the Pressing Plate]

Next, out of the control actions of the control circuit executed by the CPU 90, those pertaining to the attraction of the film to the pressing plate at the time of picture taking will be described below.

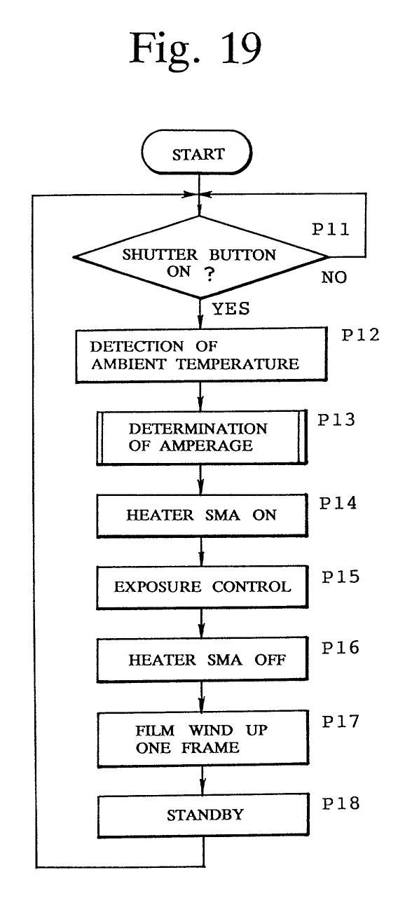

The flowchart given as FIG. 19 shows control operation by the first preferred embodiment. These control operation will be described below with reference to FIG. 19 and FIG. 1 through FIG. 3.

First, it is checked whether the shutter release button (the release switch S3) is turned ON or not (step P11). If switch S3 is turned ON, the ambient temperature is detected by the temperature sensor TX (step P12), the amperage of electric current is determined on the basis of the ambient temperature (step P14), and a current of the determined amperage is flowed to the heater SMA (the wire 20 in FIG. 1) (step P14).

The wire 20 formed of shape memory alloy is thereby heated, and the upper end of the attraction lever 18 to which the wire 20 is fixed is turned in the clockwise direction to pull the attraction shaft 16 rightward. This results in the state illustrated in FIG. 3, in which the hermetic space between the pressing plate 13 and the diaphragm 14 is expanded to generate a negative pressure, which causes the film F to be attracted to the pressing plate 13 and thereby kept flat.

The focus control by the AF circuit and the exposure control by the AE circuit are accomplished to execute exposure to light (step P15). The film F is relieved from the state in which it is attracted to the pressing plate 13 by interrupting the supply of current to the heater SMA (step P16), and the film is wound up by one frame(step P17) to stand by for the next exposing (step P18).

Although detection of the ambient temperature by the temperature sensor TS follows the checking of whether or not the shutter release button is ON in the flowchart referred to above, the timing need not be in this sequence. Nor is it necessary, when a plurality of frames are exposed consecutively, to detect the ambient temperature every time.

The control actions in the configurations of the second, third and fifth preferred embodiments are the same as those described above. The heater SMA corresponds to the coil spring 27 formed of shape memory alloy in the second embodiment (see FIGS. 4 and 5), to the heater 31 made of a nickel-chrome wire in the third embodiment (see FIG. 6), and to the coil spring 41 formed of shape memory alloy in the fifth embodiment (see FIGS. 9 and 10).

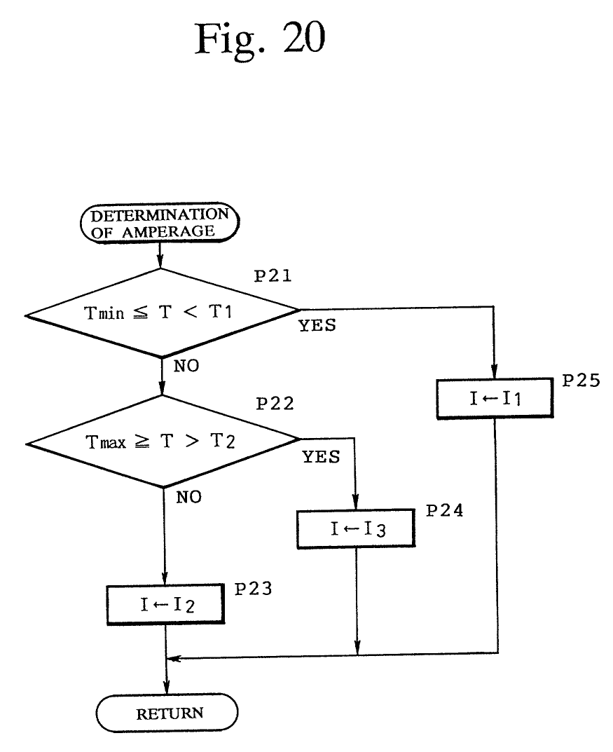

FIG. 20 is a flowchart for describing the details of the determination of the amperage of electric current referred to as step P13 in the flowchart of FIG. 19. In this case, the range of ambient temperature (environmental temperature) Tmin to Tmax, in which an apparatus incorporating a driving members using shape memory alloy is divided into three regions. More specifically, the temperature range is divided into region A lower than temperature T1, region B between temperature T1 and temperature T2, and region C higher than temperature T2. Thus, the detected ambient temperature T and temperature T1 are compared (steps P21 and P22, the amperage I is set to I1 (I←I1) if Tmin≦T<T1, i.e. the detected ambient temperature is in region A (step P25). The amperage I is set to I3 (I←I3) if Tmax≧T>T2, i.e. the detected ambient temperature is in region C (step P24). The amperage I is set to I2 (I← I2) if T1≦T≦T2, i.e. the detected ambient temperature is in region B (step P23).

Then if an electric current of I1, I3 or I2 is flowed in the case of Tmin≦T<T1, Tmax≧T>T2, T1≦T≦T2, respectively, the temperature of the heater SMA after heating will be between Austenite finish temperature TA1 and the critical heating temperature Ts.

Whereas it was earlier explained, regarding the heating of wires or the like formed of shape memory alloy, that the voltage, instead of the amperage, may be determined according to the ambient temperature, and that the duty ratio may be determined according to the ambient temperature where a pulse of a constant amperage or voltage is to be applied, the same explanation holds true with the present case, too, only if the amperage I is replaced by the voltage V or by the duty ratio D in the flowchart of FIG. 20 referred to above.

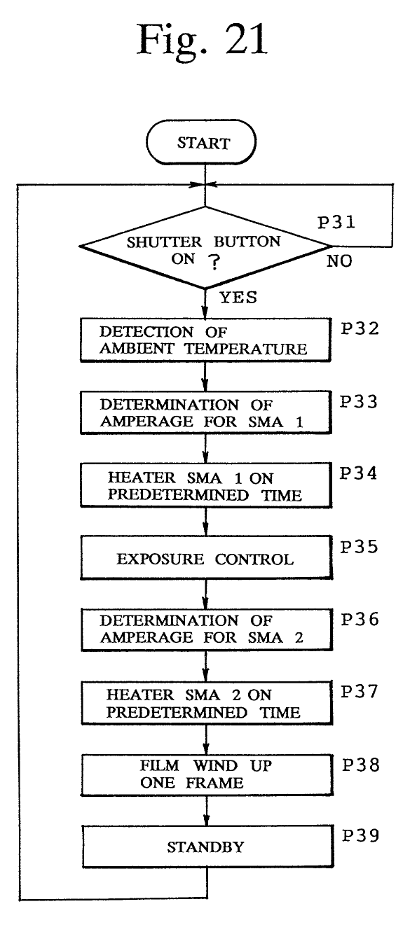

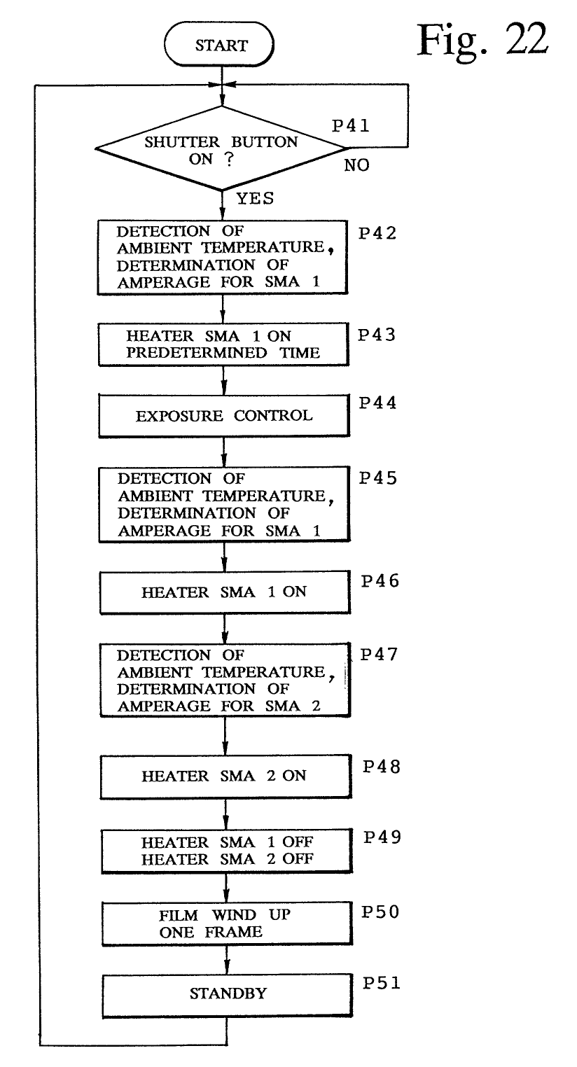

The flowchart of FIG. 21 shows the control operation in the fourth embodiment. These control operation will be described below with reference to FIG. 21 and FIGS. 7(a) and 7(b).

First, it is checked whether the shutter release button (the release switch S3) is turned ON or not (step P31). If switch S3 is turned ON, the ambient temperature is detected by the temperature sensor TS (step P32), the amperage of electric current for heater SMA1 is determined on the basis of the ambient temperature (step P33), and a current of the determined amperage is flowed to the heater SMA1 (the wire 20 in FIG. 7(a)) for a predetermined time (step P34).

As the restraining lever 36 then drops into the gap between the supporting member 15 and the block 16b of the attraction shaft 16, the attraction shaft 16 does not return to its initial position even when power supply to the heater SMA1 (the wire 20 in FIG. 7(a)) is interrupted.

As power feed to the heater SMA1 results in heating of the wire 20 formed of shape memory alloy and its contraction to the memorized shape, the upper end of the attraction lever 18 to which the wire 20 is fixed turns in the clockwise direction in FIG. 7(a) to pull the attraction shaft 16 rightward in FIG. 7(a), so that the hermetic space between the pressing plate 13 and the diaphragm 14 is expanded to generate a negative pressure, which causes the film F to be attracted to the pressing plate 13 and thereby kept flat.

The focus control by the AF circuit and the exposure control by the AE circuit are accomplished to execute exposure to light (step P35).

Next to restore the restraining lever 36 and the attraction shaft 16 to their respective initial positions, the amperage of electric current for heater SMA2 is determined according to the ambient temperature (step P36), and a current of the determined amperage is flowed to the heater SMA2 (the wire 35 in FIGS. 7(a) and 7(b)) for a predetermined time (step P37). As power feed to the heater SMA2 results in heating of the wire 35 formed of shape memory alloy and its contraction to the memorized shape, the attraction lever 36 to which the wire 35 is fixed is lifted. This causes the restraining lever 36 to come off the gap between the supporting member 15 and the block 16b of the attraction shaft 16, and the attraction shaft 16 returns to its initial position. Even if power feed to the heater SMA2 is interrupted, as the attraction shaft has returned to its initial position, the restraining lever 36 also returns to its initial position.

As the heater SMA1, power supply to which is already interrupted, has cooled, the film F is relieved from the state in which it is attracted to the pressing plate 13, and accordingly the film is wound by one frame(step P38) to stand by for the next exposing (step 39).

Although detection of the ambient temperature by the temperature sensor TX follows the checking of whether or not the shutter release button is on in the flowchart referred to above, the timing need not be in this sequence. Nor is it necessary, when a plurality of frames are taken consecutively, to detect the ambient temperature every time.

The control operation in the configuration of the sixth embodiment is the same as those described above. Thus the heater SMA1 corresponds to the wire 60, and the heater SMA 2, to the wire 64 in the sixth embodiment (see FIGS. 11 and 12).

The method for determining the amperage of the currents to be supplied to the heaters SMA1 and SMA2 is no different from that described earlier with reference to the flowchart of FIG. 20. It is also as explained earlier that that the voltage, instead of the amperage, may be determined according to the ambient temperature, and that the duty ratio may be determined according to the ambient temperature where a pulse is to be applied.

The “predetermined time” for which electric power is to be fed to the heaters SMA1 and SMA2 is a length of time needed for the wires or the like formed of shape memory alloy to reach the predetermined temperature and a sufficient length of time for the restraining lever to complete its predetermined operation, a length of time determined in advance by experiment.

The flowchart of FIG. 22 shows an alternative example of control operation in the configuration of the fourth embodiment. The control operation will be described below with reference to FIG. 22 and FIGS. 7(a) and 7(b).

First, it is checked whether the shutter release button (the release switch S3) is turned ON or not (step P41). If switch S3 is turned ON, the ambient temperature is detected by the temperature sensor TX, the amperage of electric current for heater SMA 1 is determined on the basis of the ambient temperature (step P42), and a current of the determined amperage is flowed to the heater SMA1 (the wire 20 in FIG. 7(a)) for a predetermined time (step P43).

As the restraining lever 36 then drops into the gap between the supporting member 15 and the block 16b of the attraction shaft 16, the attraction shaft 16 does not return to its initial position even when power supply to the heater SMA1 is interrupted.

As power feed to the heater SMA1 results in heating of the wire 20 formed of shape memory alloy and its contraction to the memorized shape, the upper end of the attraction lever 18 to which the wire 20 is fixed turns in the clockwise direction in FIG. 7(a) to pull the attraction shaft 16 rightward in FIG. 7, so that the hermetic space between the pressing plate 13 and the diaphragm 14 is expanded to generate a negative pressure, which causes the film F to be attracted to the pressing plate 13 and thereby kept flat. The focus control by the AF circuit and the exposure control by the AE circuit are accomplished to execute exposure (step P44).

Next to restore the restraining lever 36 and the attraction shaft 16 to their respective initial positions, the amperage of electric current for heater SAM1 is determined according to the ambient temperature (step P45), and a current of the determined amperage is flowed to the heater SMA1 (the wire 20 in FIG. 7(a)) (step P46). As this results in expansion of the gap between the supporting member 15 and the block 16b of the attraction shaft 16, it is made easier to lift the attraction lever 36.

The amperage of electric current for heater SMA2 is determined according to the ambient temperature (step P47), and a current of the determined amperage is flowed to the heater SMA2 (the wire 35 of FIGS. 7(a) and 7(b)) (step P48). As power feed to the heater SMA2 results in heating of the wire 35 formed of shape memory alloy and its contraction to the memorized shape, the attraction lever 36 is lifted by the wire 35. This causes the restraining lever 36 to come off the gap between the supporting member 15 and the block 16b of the attraction shaft 16, and the attraction shaft 16 returns to its initial position. Even if power feed to the heater SMA2 is interrupted, as the attraction shaft 16 has returned to its initial position, the restraining lever 36 also returns to its initial position.

After that, power supply to the heaters SMA1 and SMA2 is interrupted (step P49). As this relieves the film F of the state in which it is attracted to the pressing plate 13, the film is wound by one frame (step P50) to stand by for the next exposing (step 51).

[Seventh Embodiment]

The film flatness keeping devices explained in the first through sixth embodiments, are so configured that, after the film is fed to the aperture section, a wire(s) formed of shape memory alloy is heated to actuate an attraction mechanism to attract the film to a pressing plate and thereby to keep the film flat.

With this configuration, if the film is allowed to stand for a long period before the whole roll has been exposed, the film in the camera body may slightly move to invite a frame slippage.

The embodiment described below has a configuration in which the attraction of the film to the pressing plate is suspended only during the period of feeding the film within the camera, and the film is kept attracted to the pressing plate during the period in which the film is not fed even in a state wherein power supply in the camera is interrupted, so that no frame slippage occurs even when the camera is allowed to stand for a long period before the whole roll has been exposed.

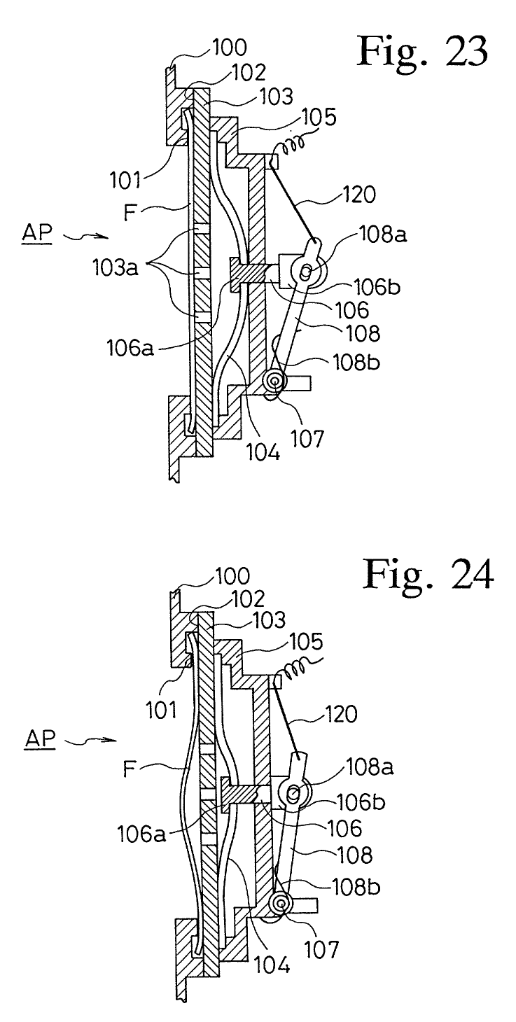

FIGS. 23 and 24 illustrate the configuration of a film flatness keeping device, which is a seventh embodiment. FIG. 23 is a cross section view of the state in which the film is attracted to the pressing plate, and FIG. 24 is a cross section view of the state being relieved from that attraction.

In FIGS. 23 and 24, reference numeral 100 denotes a camera body, in whose aperture section AP are formed film rails 101 and pressing plate rails 102. A pressing plate 103 disposed on the rear lid side of the camera (not shown) is provided with orifices 103a for attracting a film F to the pressing plate 103. Reference numeral 105 denotes a supporting member fitted to the pressing plate 103. The pressing plate 103 and the supporting member 105 are so disposed that the pressing plate 103 be pressed against the pressing plate rails 102 by elastic members (not shown) such as springs when the rear lid of the camera is closed. Reference letter F denotes a film.

The supporting member 105 has a bearing at its lower end, and a shaft 107 supported by the bearing supports an attraction lever 108 swingably. An attraction shaft 106 penetrates the central part of the supporting member 105.

The end of the attraction shaft 106 on the pressing plate 103 side is formed into a disc-shaped end 106a, whose diameter is greater than the diameter of the shaft, and a block 106b, which is the other end of the attraction shaft 106, is provided with a pin 108a to be connected to the upper end area of the attraction lever 108.

A diaphragm 104 is formed of rubber or any other suitable flexible material, and the parts around the diaphragm 104 are squeezed tightly by the pressing plate 103 and the supporting member 105 so that a hermetic space be formed between the pressing plate 103 and the diaphragm 104 except orifices 103a. The attraction shaft 106 penetrates the central part of the diaphragm 104, so disposed that, when the attraction shaft 106 shifts rightward in FIG. 23, the hermetic space between the pressing plate 103 and the diaphragm 104 be expanded.

The attraction lever 108 is supported to be swingable around the shaft 107, and is subjected to the springing force of a spring 108b in the clockwise direction in FIG. 23. A wire 120 formed of shape memory alloy is fixed to the upper end part of the attraction lever 108, and the end of the wire 120 is fixed, to be able to receive electric power feed, to a terminal 105a provided on the supporting member 105. The wire 120 formed of shape memory alloy is memorized a shape in the contracting direction, and contracts to the memorized shape when heated.

Next will be described the operation of this configuration. First, when the camera is to be loaded with a film and the frame to be exposed fed to the aperture section AP of the camera body, the wire 120 formed of shape memory alloy is electrified and heated to be contracted to its shape memorized in advance. The attraction lever 108 moves to the position illustrated in FIG. 24 against the force given by a spring 108b, and causes the attraction shaft 106 leftward in FIG. 23. Since the pulling force of the attraction shaft does not work on the diaphragm 104 at this time, the negative pressure between the pressing plate 103 and the diaphragm 104 decreases, resulting in a state in which the film is relieved from the attracting force. As the film F is not attracted by the pressing plate 103, it can be freely fed along the surface of the pressing plate.

When power feed to the wire 120 formed of shape memory alloy is interrupted, the wire 120 is cooled to be restored to its initial shape. The attraction lever 108, which is given a force in the clockwise direction by the spring 108b, moves to its position shown FIG. 23, and pulls the attraction shaft 106 rightward. As this action also pulls the central part of the diaphragm 104 rightward, the hermetic space between the pressing plate 103 and the diaphragm 104 is expanded to generate a negative pressure, which causes the film F before the pressing plate 103 to be attracted to the pressing plate 103 into an attracted state, and the part of the film F in the aperture section AP to be kept flat and prevented from moving. In this state, it is possible either to photograph or not to photograph.

When the film F is to be wound or rewound, the wire 120 formed of shape memory alloy is again electrified, the attraction lever 108 moved to its position shown in FIG. 24, and the film F relieved from attraction to the pressing plate 103.

[Eighth Embodiment]

The eighth embodiment differs in configuration from the seventh embodiment in that, once the wire 120 formed of shape memory alloy is electrified and heated to relieve the film of attraction by the pressing plate, the film remains relieved from attraction to the pressing plate even when power supply to the wire 120 is interrupted.

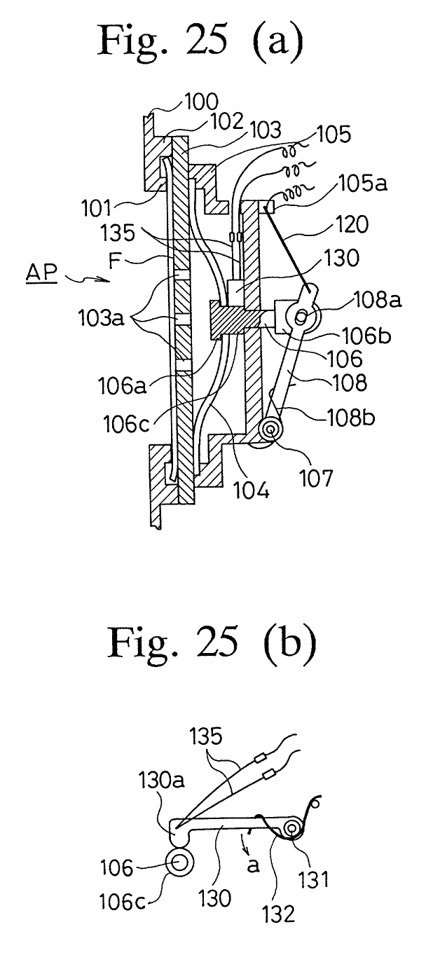

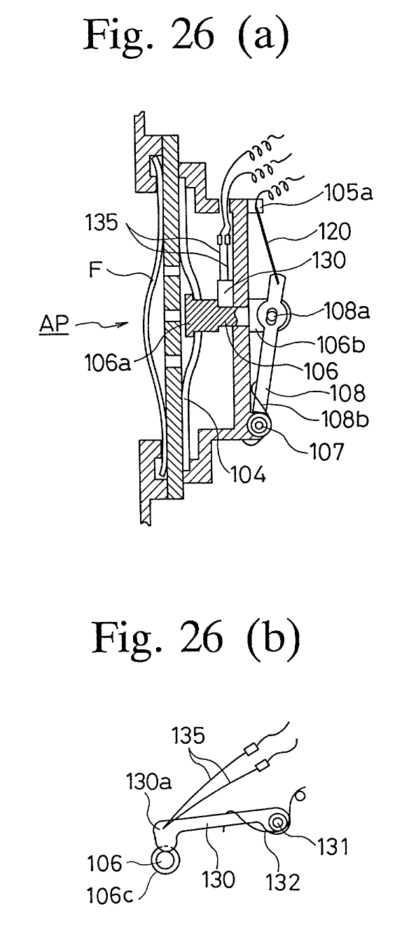

FIGS. 25(a) to 26(b) illustrate the configuration of a film flatness keeping device of the eighth embodiment. FIG. 25(a) shows a cross section view of the state in which the film is attracted to the pressing plate and FIG. 25(b) is a diagram illustrating the configuration and operation of the engaging part thereof.

FIG. 26(a) is a cross section view of the state being relieved from that attraction, and FIG. 26(b) is a diagram illustrating the configuration and operation of the engaging part thereof. Since the configuration of the eighth embodiment resembles that of the seventh embodiment described with reference to FIGS. 23 and 24, the same members are assigned respectively the same reference signs, and their detailed description is dispensed with, but only the differences will be described.

As illustrated in FIG. 25(a), the attraction shaft 106 penetrates the supporting member 105, and a restraining lever 130 is arranged upper part of the attraction shaft 106.

The end of the attraction shaft 106 on the pressing plate 103 side is formed into a disc-shaped end 106a, whose diameter is greater than the diameter of the shaft, while the part behind the end 106a is formed into a large diameter section 106c, whose diameter is greater than the diameter of the part of the shaft where it penetrates the supporting member 105. The block 106b, which is the other end of the attraction shaft 106, is provided with the pin 108a to be connected to the upper end area of the attraction lever 108.

The diaphragm 104 is formed of rubber or any other suitable flexible material, and the parts around the diaphragm 104 are squeezed tightly against each other by the pressing plate 103 and the supporting member 105 so that a hermetic space be formed between the pressing plate 103 and the diaphragm 104 except orifices 103a. The attraction shaft 106 penetrates the central part of the diaphragm 104, so disposed that, when the attraction shaft 106 shifts rightward in FIG. 25a, the hermetic space between the pressing plate 103 and the diaphragm 104 be expanded.

The attraction lever 108 is supported to be swingable around the shaft 107, and is subjected to the springing force of a spring 108b in the clockwise direction in FIG. 25. The wire 120 formed of shape memory alloy is fixed to the upper end part of the attraction lever 108, and the end of the wire 120 is fixed, to be able to receive electric power feed, to the terminal 105a provided on the supporting member 105. The wire 120 formed of shape memory alloy is memorized a shape in the contracting direction, and contracts to the memorized shape when heated.

One end of the restraining lever 130, as shown in FIG. 25(b), is supported by a shaft 131, and given a force in the direction of arrow a by a spring 132. Near a tip 130a of the restraining lever 130 is fixed a wire 135 which, formed of shape memory alloy, memorizes a shape in the contracting direction. The tip 130a of the restraining lever 130 is formed in dimensions matching a gap which is formed between the supporting member 105 and the large diameter section 106c of the attraction shaft 106 so that the tip 130a can drop into this gap when the attraction shaft 106 moves rightward in FIG. 25(a).

Next will be described the operation of this configuration. First, when the camera is to be loaded with a film and the frame to be exposed fed to the aperture section AP of the camera body, the wire 120 formed of shape memory alloy is electrified and heated to be contracted to its shape memorized in advance. The attraction lever 108 moves to the position illustrated in FIG. 26(a) against the force given by the spring 108b. Since the pulling force of the attraction shaft 106 does not work on the diaphragm 104, the negative pressure between the pressing plate 103 and the diaphragm 104 decreases, resulting in a state in which the film is relieved from the attracting force. As the film F is not attracted by the pressing plate 103, it can be freely fed along the surface of the pressing plate.

The tip 130a of the restraining lever 130 then drops into the gap between the supporting member 105 and the large diameter section 106c of the attraction shaft 106 as shown in FIG. 26(a) and FIG. 26(b), and thereby prevents the attraction shaft 106 from returning to its position in the attraction state.

When the attraction state is to be restored, the wire 135 formed of shape memory alloy, fixed near the tip 130a of the restraining lever 130, is electrified and heated. The wire 135 contracts to the shape memorized in advance, and lifts the restraining lever 130 to the position shown in FIG. 25(b). When power feed to the wire formed of shape memory alloy is interrupted, the wire 120 returns to its shape in the cooled state, and, as the attraction lever 108 is given a force in the clockwise direction by the spring 108b, it moves to its position shown in FIG. 25(a) and pulls the attraction shaft 106 rightward. As this action also pulls the central part of the diaphragm 104 rightward, the hermetic space between the pressing plate 103 and the diaphragm 104 is expanded to generate a negative pressure, which causes the film F before the pressing plate 103 to be attracted to the pressing plate 103 and the part of the film F in the aperture section AP to be kept flat and prevented from moving. In this state, it is possible either to photograph or not to photograph.

When the film F is to be wound or rewound, the wire 120 is again electrified, the attraction lever 180 moved to its position shown in FIG. 26(a), and the film F relieved from attraction to the pressing plate 103.

[Ninth Embodiment]

The ninth embodiment also has a mechanism to maintain the attraction-relieved state once the film is relieved from its state of being attracted to the pressing plate even when power feed to the shape memory alloy wire is interrupted, and a drive mechanism for these actions is disposed in a hermetic chamber.

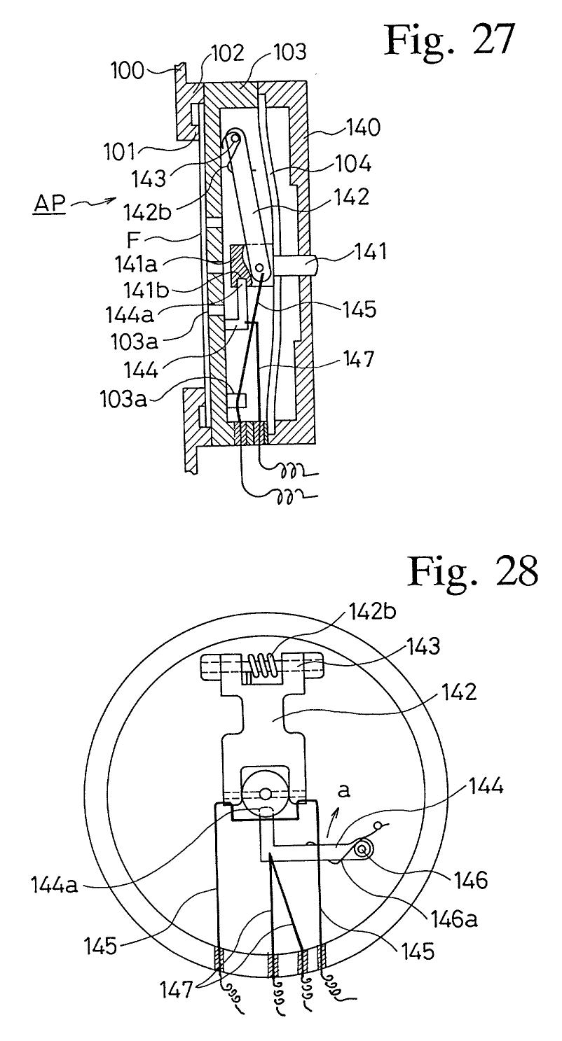

FIGS. 27 and 28 illustrate the configuration of a film flatness keeping device of the ninth embodiment. FIG. 27 shows the cross section view of the state in which the film is attracted to the pressing plate and FIG. 28 is an elevation view of the essential parts thereof as viewed from the rear side (the right side in FIG. 27).

Reference numeral 100 denotes a camera body, in whose aperture section AP are formed the film rails 101 and pressing plate rails 102. The pressing plate 103 disposed on the rear lid side of the camera (not shown) is provided with the orifices 103a for attracting a film F to the pressing plate 103. Reference numeral 140 denotes a supporting member fitted to the pressing plate 103. The pressing plate 103 and the supporting member 140 are so disposed that the pressing plate 103 be pressed against the pressing plate rails 102 by elastic members (not shown) such as springs when the rear lid of the camera is closed. Reference letter F denotes a film.

As illustrated in FIG. 27, an attraction shaft 141 penetrates the supporting member 140, and underneath the penetrating attraction shaft 141 is arranged a restraining lever 144.

The attraction lever 142 is supported to be swingable around a shaft 143 provided on the pressing plate 103, and is subjected to the force of a spring 142b in the clockwise direction in FIG. 27. A wire 145 formed of shape memory alloy is fixed to the lower end part of the attraction lever 142, and the end of the wire 145 is fixed, to be able to receive electric power feed, to a terminal 103a provided on the pressing plate 103. The wire 145 formed of shape memory alloy is memorized a shape in the contracting direction, and contracts to the memorized shape when heated.

One end of the restraining lever 144, as shown in FIG. 28, is supported by a shaft 146, and given a force in the direction of arrow a by a spring 146a. To the restraining lever 144 is fixed a wire 147 which, formed of shape memory alloy, memorizes a shape in the contracting direction. It is so configured that a tip 144a of the restraining lever 144 engage with an engaging groove 141b formed in a block 144a of the attraction shaft 141 when the attraction shaft 141 moves leftward in FIG. 27, and thereby restrain the shifting of the attraction shaft 141 in the axial direction.

Next will be described the operation of this configuration. First, when a film has been loaded in the camera and the frame to be exposed fed to the aperture section AP of the camera body, the wire 145 formed of shape memory alloy is electrified and heated to be contracted to its shape memorized in advance. The attraction lever 142 moves leftward in FIG. 27 against the force given by the spring 142b, and the attraction shaft 141 also moves leftward in FIG. 27. Since the pulling force of the attraction shaft 141 does not work on the diaphragm 104, the negative pressure between the pressing plate 103 and the diaphragm 104 decreases, resulting in a state in which the film is relieved from the attracting force. As the film F is not attracted by the pressing plate 103, it can be freely fed along the surface of the pressing plate.

The tip 144a of the restraining lever 144 then engages with the engaging groove formed in the block 141b of the attraction shaft 141, and the attraction-relieved state is maintained even when power feed to the shape memory alloy wire is interrupted.

When the attraction state is to be restored, the wire 147 formed of shape memory alloy, fixed to the restraining lever 144, is electrified and heated, and thereby contracted to the shape memorized in advance. When the restraining lever 144 is pulled downward in FIGS. 27 and 28, the engagement between the tip 144a of the restraining lever 144 and the engaging groove 141b of the block 141a of the attraction shaft 141 is released, so that the attraction shaft 141 is caused to move rightward in FIG. 27 by the attraction lever 142 which is given a force in the counter-clockwise direction by the spring 142b, and the central part of the diaphragm 104 also moves rightward.

As this results in expansion of the hermetic space between the pressing plate 103 and the diaphragm 104 to generate a negative pressure, which causes the film F before the pressing plate 103 to be attracted to the pressing plate 103 and the part of the film F in the aperture section AP to be kept flat and prevented from moving. In this state, it is possible either to photograph or not to photograph.

When the film F is to be wound or rewound, wire 145 formed of shape memory alloy is again electrified, the attraction lever 142 moved leftward, and the film F relieved from attraction to the pressing plate 103.

[Control of the Attraction of the Film to the Pressing Plate and of the Relief of Attraction]

With regard to the configuration which, as described with reference to the seventh through ninth embodiments, allows the attraction of the film to the pressing plate to be suspended only during the feeding of the film within the camera and causes the film to remain attracted to the pressing plate when it is not being fed even when power supply in the camera is interrupted, the control actions of the control circuit will be described below.

Description of the configuration of the control circuit is omitted here because it is no different from that described with reference to FIG. 18, but only the control operation will be described.

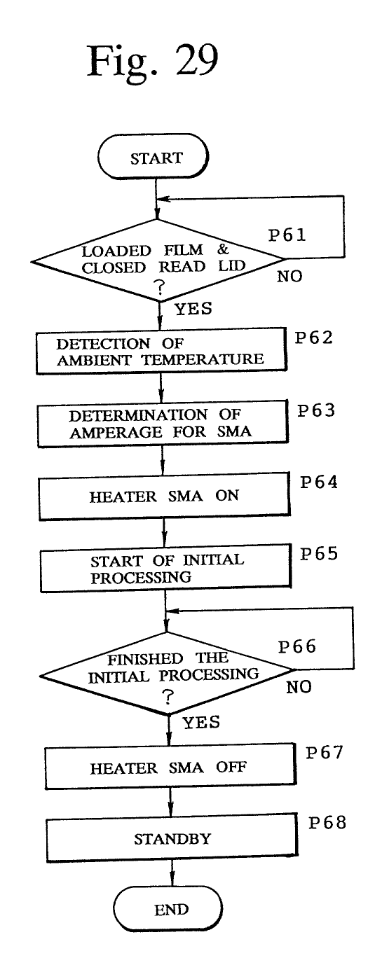

The flowchart of FIG. 29 shows initial processing at the time of loading a film in the camera in the control operation of the seventh embodiment. The control operation for the initial processing will be described below with reference to FIGS. 29, 23 and 24.

First, it is checked whether a film has been loaded in the camera and its rear lid closed or not (step P61). When it is found closed, the ambient temperature is detected by the temperature sensor TX (step P62), the amperage is determined on the basis of the ambient temperature (step P63), and a current of the determined amperage is flowed to the heater SMA (the wire 120 in FIG. 23) (step P64). So far is preliminary processing for the attraction of the film to the pressing plate, i.e. processing to reduce the volume of the hermetic space between the pressing plate 103 and the diaphragm 104. Thus, when the wire 120 formed of shape memory alloy is electrified and heated, the upper end of the attraction lever 118 to which the wire 120 is fixed turns in the counterclockwise direction in FIG. 23, the attraction shaft 16 moves leftward in FIG. 23, and the volume of the hermetic space between the pressing plate 103 and the diaphragm 104 decreases, resulting in an attraction-relieved state. This enables a film feeding operation to be executed thereafter.

Initial processing following the loading a film is started, and the completion of this initial processing is awaited (steps P65 and 66). Whereas feeding of the first frame of the film to the exposure position is accomplished during this waiting period, the feeding can be carried out easily because the attraction shaft 106 is in the leftward-shifted position in FIG. 24 and performs no attracting action at this point of time. When the initial processing has been completed, heating of the heater SMA is discontinued, and entered into a waiting state (steps P67 and P68). At this time the heating of the heater SMA has been interrupted, and the attraction shaft 106 and the central part of the diaphragm 104 move rightward in FIG. 23, resulting in an attraction state, wherein the film is attracted to the pressing plate.

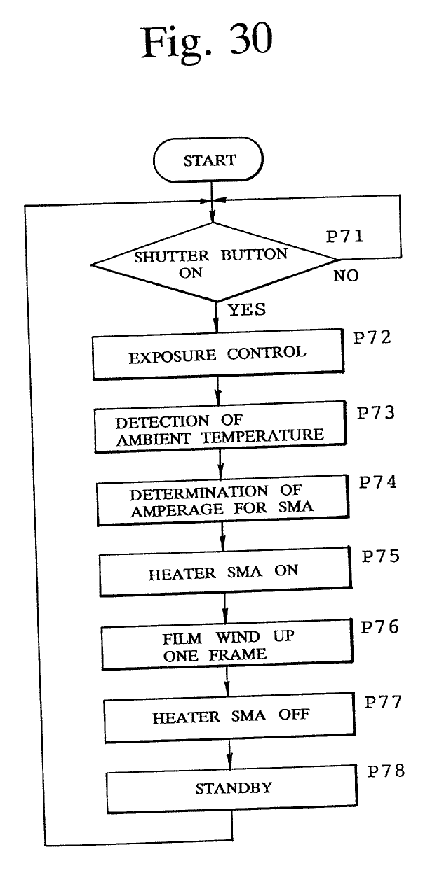

The flowchart of FIG. 30 shows processing at the time of feeding the film after the exposure of each frame and at the time of rewinding the film, in the control operation of the seventh embodiment. The control operation will be described below with reference to FIGS. 30, 23 and 24.

It is supposed that by this point of time, initial processing has been completed, and an unexposed frame of the film has been fed to the exposure position and attracted by the pressing plate. It is checked whether the shutter release button (the release switch S3) is ON or not (step P71). If switch S3 is turned ON, the focus control by the AF circuit and the exposure control by the AE circuit are accomplished to execute exposure (step P72).

The ambient temperature is detected by the temperature sensor TX (step P73), and the amperage of electric current is determined on the basis of the ambient temperature (step P75). This causes the attraction shaft 106 to move leftward in FIG. 23, and the volume of the hermetic space between the pressing plate 103 and the diaphragm 104 decreases, resulting in the relief of the film from the state of being attracted to the pressing plate.

The film is wound by one frame (step P76), the current flow to the heater SMA is interrupted (step P77), and a waiting state for the next exposure is entered into (step P78). As current feeding to the heater SMA is discontinued, the attraction shaft 106 moves rightward in FIG. 23, and the volume of the hermetic space between the pressing plate 103 and the central part of the diaphragm 104 increases, resulting in the resumption of the state wherein the film is attracted to the pressing plate.

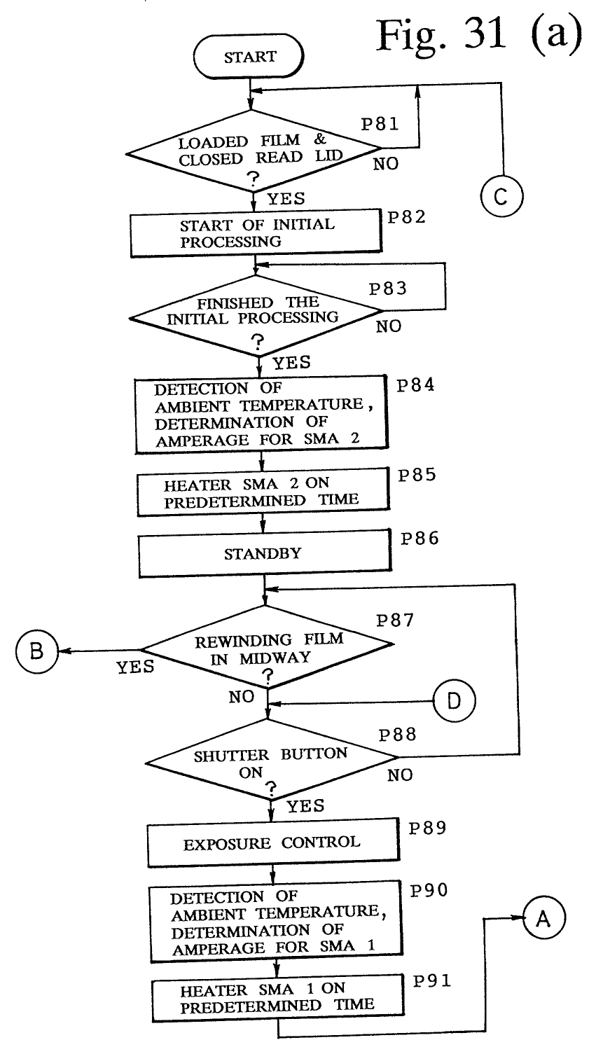

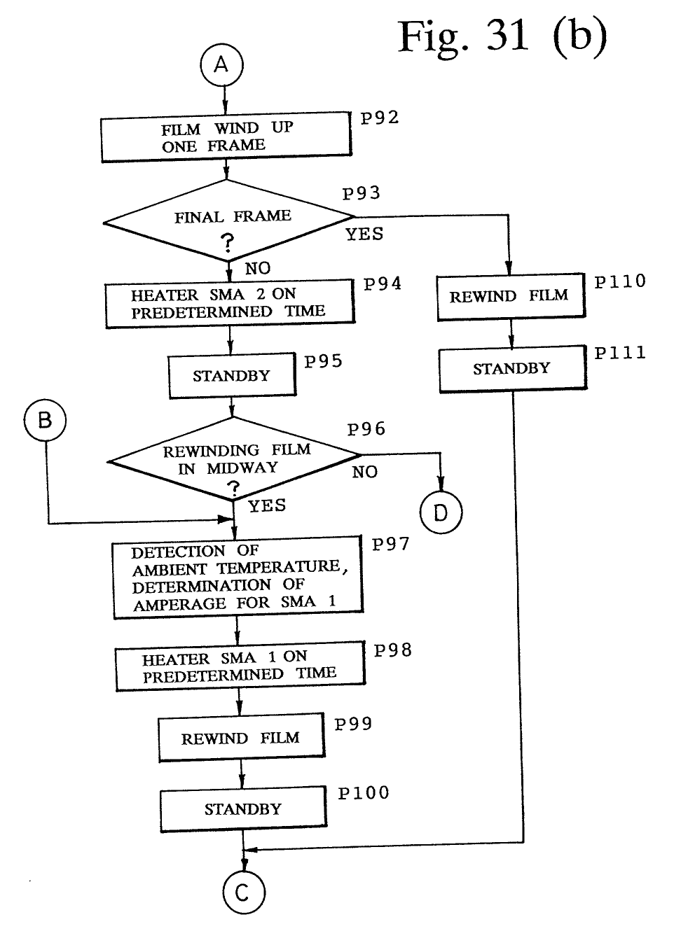

The flowcharts of FIGS. 31(a) and 31(b) show control operation of the eighth embodiment. The control operation will be described below with reference to FIGS. 31(a), 31(b), 25(a) to 26(b).

First, it is checked if a film has been loaded in the camera and its rear lid closed (step P81). When rear lid is found closed, initial processing following the loading of film is started, and the completion of this initial processing is awaited (steps P82 and P83). Whereas feeding of the first frame of the film to the exposure position is accomplished during this waiting period, the feeding can be carried out easily because no attracting action is performed at this point of time.

The ambient temperature is detected by the temperature sensor TX, the amperage of electric current for heater SMA2 is determined on the basis of the ambient temperature (step P84), a current of the determined amperage is flowed to the heater SMA2 (the wire 135 in FIG. 25) (step P85), and entered into a waiting state (step P86). This is processing to relieve the restraint by the restraining lever 130 to enable the film to be attracted to the pressing plate, resulting in the attraction state illustrated in FIG. 25(a).

It is judged whether or not the film rewinding is instructed on the way (the rewinding switch is ON or not) (step P87); if it is not, the turning-ON of the shutter release button (the release switch S3) is awaited (step P88); and the focus control by the AF circuit and the exposure control by the AE circuit are accomplished to execute exposure (step P89).

The ambient temperature is detected by the temperature sensor TX, the amperage of electric current for heater SMA1 is determined on the basis of the ambient temperature (step P90), and a current of the determined amperage is flowed to the heater SMA1 (the wire 120 in FIG. 25) (step P91). As this causes the attraction shaft 106 to move leftward in FIG. 25(a), and the film is relieved from the state of being attracted to the pressing plate, the film is wound by one frame (step P92).

It is judged whether or not the final frame has been exposed (step S93); if it has, the film is rewound; and a waiting state is entered into (steps P110 and P111). If it has not, a current of the amperage determined on the basis of the ambient temperature is flowed to the heater SMA2 (the wire 135 in FIG. 25(b)), and a waiting state is entered into (steps P94 and P95).

It is judged whether or not the film rewinding is instructed on the way (step P96); if it is not, the processing at and after step P88 is performed. If it is, the amperage of electric current for heater SMA1 is determined on the basis of the ambient temperature (step P97), and a current of the determined amperage is flowed to the heater SMA1 (the wire 120 in FIG. 25(a)) (step P98). As this causes the attraction shaft 106 to move leftward in FIG. 25(a); the film is relieved from the state of being attracted to the pressing plate, and the film is enabled to be rewound, it is rewound, and entered into a waiting state (steps P99 and P100). If it is judged at step P87 that the film rewinding is instructed on the way, the processing at and after step P97 will also be followed.

Furthermore, it goes without saying that the scope of claims of the present invention includes not only any camera provided with a film flatness keeping device having a drive mechanism using shape memory alloy but also any rear lid unit provided with such a film flatness keeping device and any drive mechanism itself using shape memory alloy.

As hitherto described, there is provided a drive mechanism using shape memory alloy in which a driving member formed of a shape memory alloy and caused to memorize a predetermined shape in advance, is heated by supplying a current, a voltage or a pulse current or a pulse voltage of a predetermined duty ratio, and driven elements are driven on the basis of the displacement occurring when the member has restored its memorized predetermined shape, the drive mechanism comprising a temperature sensor for measuring the ambient temperature and a controller for supplying the current, the voltage or the pulse current or the pulse voltage of a predetermined duty ratio for heating the driving member formed of the shape memory alloy, and controlled by the controller so as to determine the amperage, the voltage or the predetermined duty ratio for the power supply to the driving member formed of the shape memory alloy on the basis of the ambient temperature measured by the temperature sensor.

Since this configuration enables the temperature of heating the driving member formed of the shape memory alloy to be appropriately controlled according to the ambient temperature and prevents the member from overheating, there is no fear for the shape memorized in the driving member to be weakened or lost by overheating, and the driven elements can be accurately driven even if the driving member is subjected to alternate heating and heating stop repeatedly. Furthermore, because control at each temperature is possible with the minimum required electric power for deforming the driving member, power consumption can be kept to the minimum.

Moreover, since this drive mechanism can be composed of a relatively small number of members in a compact and light-weight configuration, it is possible to provide it in a form suitable for cameras and other items which need to be compact and light.

Incidentally, although the foregoing embodiments are drive mechanisms for keeping a photographic film flat in the camera, it goes without saying that the applicability of this invention is not limited to them. Furthermore, the invention can be applied to all kinds of drive mechanisms including but not limited to those for cameras and to apparatuses provided with drive mechanisms.

What is claimed is:

1. An apparatus comprising:
a driving member formed of a shape memory alloy memorizing a desired shape in advance, and a driven member driven by this driving member;
a controller for controlling an amperage or a voltage fed to the driving member to heat the driving member to displace it into said desired shape; and
a temperature sensor for measuring the ambient temperature, wherein
said controller determines, on the basis of the measured ambient temperature, said amperage or voltage to be fed so that the temperature of said driving member be more than the phase transformation finish temperature upon heating thereof but less than a predetermined temperature irrespective of the ambient temperature.

2. An apparatus, as claimed in claim 1, wherein:
the controller reduces said amperage or voltage to be fed with an increase in the measured ambient temperature.

3. An apparatus, as claimed in claim 1, wherein:
the ambient temperature is divided into a plurality of temperature regions, for each of which the amperage or the voltage is set in advance so that the temperature of said driving member be more than the phase transformation finish temperature upon heating thereof but less than a predetermined temperature, and
the controller judges which temperature region the measured ambient temperature belongs to, and effects control so that said amperage or voltage to be fed be equal to a value set in advance for that temperature region.

4. An apparatus, as claimed in claim 1, wherein:
a predetermined functional formula of the amperage or the voltage is set in advance so that the temperature of said driving member be more than the phase transformation finish temperature upon heating thereof but less than a predetermined temperature, and
the controller calculates an amperage or a voltage by said functional formula, and effects control so that said amperage or voltage to be fed be equal to the calculated value.

5. An apparatus, as claimed in claim 1, wherein:
said predetermined temperature is said transformation finish temperature plus 60 degrees centigrade.

6. An apparatus, as claimed in claim 1, wherein:
the driven member driven by said driving member is controlled so that it operate between a first stop position and a second stop position.

7. An apparatus, as claimed in claim 1, wherein:
said apparatus is a camera.

8. An apparatus, as claimed in claim 1, wherein:
said apparatus is a rear lid unit of a camera.

9. A drive mechanism using shape memory alloy comprising:
a driving member formed of a shape memory alloy memorizing a desired shape in advance;
a controller for controlling an amperage or a voltage fed to the driving member to heat the driving member to displace it into said desired shape; and
a temperature sensor for measuring the ambient temperature, wherein
said controller determines, on the basis of the measured ambient temperature, said amperage or voltage to be fed so that the temperature of said driving member be more than the phase transformation finish temperature upon heating thereof but less than a predetermined temperature irrespective of the ambient temperature.

10. A drive mechanism, as claimed in claim 9, wherein:
the controller reduces said amperage or voltage to be fed with an increase in the measured ambient temperature.

11. A drive mechanism, as claimed in claim 9, wherein:
the ambient temperature is divided into a plurality of temperature regions, for each of which an amperage or a voltage is set in advance so that the temperature of said driving member be more than the phase transformation finish temperature upon heating thereof but less than a predetermined temperature, and
the controller judges which temperature region the measured ambient temperature belongs to, and effects control so that said amperage or voltage to be fed be equal to a value set in advance for that temperature region.

12. A drive mechanism, as claimed in claim 9, wherein:
a predetermined functional formula of the amperage or the voltage is set in advance so that the temperature of said driving member be more than the phase transformation finish temperature upon heating thereof but less than the predetermined temperature, and
the controller calculates an amperage or a voltage by said functional formula, and effects control so that said amperage or voltage to be fed be equal to the calculated value.

13. A drive mechanism, as claimed in claim 9, wherein:
said predetermined temperature is said transformation finish temperature plus 60 degrees centigrade.

14. An apparatus comprising:
a driving member formed of a shape memory alloy memorizing a desired shape in advance, and a driven member driven by this driving member;
a controller for controlling the duty ratio of a pulse voltage or a pulse current fed to the driving member to heat the driving member to displace it into said desired shape; and
a temperature sensor for measuring the ambient temperature, wherein
said controller determines, on the basis of the measured ambient temperature, the duty ratio so that the temperature of said driving member be more than the phase transformation finish temperature upon heating thereof but less than a predetermined temperature irrespective of the ambient temperature.

15. An apparatus, as claimed in claim 14, wherein:
the higher the measured ambient temperature, the shorter the duration of power feed for the duty ratio the controller selects.

16. An apparatus, as claimed in claim 14, wherein:
the ambient temperature is divided into a plurality of temperature regions, for each of which the duty ratio is set in advance so that the temperature of said driving member be more than the phase transformation finish temperature upon heating thereof but less than a predetermined temperature, and
the controller judges which temperature region the measured ambient temperature belongs to, and effects control so that the duty ratio of a supplied current or of a supplied voltage be equal to a value set in advance for that temperature region.

17. An apparatus, as claimed in claim 14, wherein:
a predetermined functional formula of the duty ratio is set in advance so that the temperature of said driving member be more than the phase transformation finish temperature upon heating thereof but less than a predetermined temperature, and
the controller calculates the duty ratio by said functional formula, and effects control so that the duty ratio of a supplied current or of a supplied voltage be equal to the calculated value.

18. An apparatus, as claimed in claim 14, wherein:
said predetermined temperature is said transformation finish temperature plus 60 degrees centigrade.

19. An apparatus, as claimed in claim 14, wherein:
the driven member driven by said driving member is controlled so that it operate between a first stop position and a second stop position.

20. An apparatus, as claimed in claim 14, wherein:
said apparatus is a camera.

21. An apparatus, as claimed in claim 14, wherein:
said apparatus is a rear lid unit of a camera.

22. A drive mechanism using shape memory alloy comprising:
a driving member formed of a shape memory alloy memorizing a desired shape in advance;
a controller for controlling the duty ratio of a pulse voltage or a pulse current supplied to the driving member to heat the driving member to displace it into said desired shape; and
a temperature sensor for measuring the ambient temperature, wherein
said controller determines, on the basis of the measured ambient temperature, the duty ratio so that the temperature of said driving member be more than the phase transformation finish temperature upon heating thereof but less than a predetermined temperature irrespective of the ambient temperature.

23. A drive mechanism, as claimed in claim 22, wherein:
the higher the measured ambient temperature, the shorter the duration of power feed for the duty ratio the controller selects.

24. A drive mechanism, as claimed in claim 22, wherein:
the ambient temperature is divided into a plurality of temperature regions, for each of which the duty ratio is set in advance so that the temperature of said driving member be more than the phase transformation finish temperature upon heating thereof but less than a predetermined temperature, and
the controller judges which temperature region the measured ambient temperature belongs to, and effects control so that the duty ratio of a supplied current or of a supplied voltage be equal to a value set in advance for that temperature region.

25. A drive mechanism, as claimed in claim 22, wherein:
a predetermined functional formula of the duty ratio is set in advance so that the temperature of said driving member be more than the phase transformation finish temperature upon heating thereof but less than a predetermined temperature, and
the controller calculates the duty ratio by said functional formula, and effects control so that the duty ratio of a supplied current or of a supplied voltage be equal to the calculated value.

26. A drive mechanism, as claimed in claim 22, wherein:
said predetermined temperature is said transformation finish temperature plus 60 degrees centigrade.

27. A drive mechanism, as claimed in claim 22, wherein:
the driven member driven by said driving member is controlled so that it operate between a first stop position and a second stop position.
